(19) United States
(12) Patent Application Publication
(10) Pub. No.: US 2013/0313387 A1
(43) Pub. Date: Nov. 28, 2013

(54) CUSTOMIZABLE ORGANIZER ASSEMBLY

(71) Applicant: Long Ly, West Hills, CA (US)

(72) Inventor: Long Ly, West Hills, CA (US)

(21) Appl. No.: 13/902,603

(22) Filed: May 24, 2013

Related U.S. Application Data
(60) Provisional application No. 61/652,126, filed on May 25, 2012.
(60) Provisional application No. 61/769,638, filed on Feb. 26, 2013.

(51) Int. Cl. F16M 13/02

(52) U.S. Cl. CPC F16M 13/02
USPC 248/205.3; 248/200; 248/213.2; 248/206.5; 248/205.1

(57) ABSTRACT

The present invention is preferably a customizable organizer assembly that allows a user to organize accessories in a home or workspace by mounting or attaching various accessory mount assemblies to a fixture assembly or other object. The fixture assembly is preferably configured to attach to any surface such as a wall or ceiling, and the accessory mount assembly is preferably configured to removeably attach to the fixture assembly or other surface via fasteners. Each accessory mount assembly generally includes an accessory that functions as a different organizational tool that the user may use within his or her workspace or living space, and various embodiments of the accessory mount assembly may be used alone or in combination with the fixture assembly, depending on the needs of the user.

### CROSS REFERENCE TO RELATED APPLICATIONS

This application takes priority from U.S. Provisional Patent Application No. 61/652,126, filed on May 25, 2012, titled “Universal Organizer/Storage/Personalization/Workspace Assistance/Accessories Mounting Device”, by inventor Long Ly, the contents of which are expressly incorporated herein by this reference as though set forth in their entirety, and to which priority is claimed. Priority is also claimed from U.S. Provisional Patent Application No. 61/769,638, filed on Feb. 26, 2013, titled “Fully Customizable—Universal Organizer Assembly”, by inventor Long Ly, the contents of which are expressly incorporated herein by this reference as though set forth in their entirety, and to which priority is claimed.

### FIELD OF INVENTION

The present invention relates generally to organizers that are customizable according to the preference of a user, and more particularly, customizable organizer assemblies, wherein a user may removeably attach various accessories using one or more accessory mount assemblies that may removeably engage with a customizable fixture assembly and/or other furniture and fixtures such as tables, countertops, and refrigerators.

### BACKGROUND

For decades, people have created various storage products and organizational accessories to assist themselves in organizing their lives. Examples of such products include hangers for hanging articles of clothing, shelves for holding books, and electronic devices, such as personal digital assistance devices. Additionally, magnetic surfaces such as refrigerator doors have been used to hold photographs, notes, and reminders, and containers have been used to store various small items. Furthermore, drawers, cabinet, other compartments have been commonly utilized to loosely store a variety of objects.

Current storage and organizational products, however, have numerous deficiencies. For example, most storage and organizational products fail to provide the user with the versatility in customizing the organizer product according to the needs or preferences of a particular user and are generally not movable (e.g., users cannot simply take organizational accessories out from a kitchen platform and use those same accessories on a refrigerator, hanger bars in a closet, or shelving in a garage). Additionally, most desks and hutches lack fastening mechanisms to attach various small items in need of a storage or organization. Wall surfaces and closet doors generally do not include, or cannot be easily converted into, a magnetic surface to hold notes, reminders, and metallic/non-metallic tools. Furniture items generally do not include fastening mechanisms for incorporating electronic devices such as thermometers, calculators, and hygrometers, and most shelves generally do not include hanger bars to hang hooked items. There has been no fixture assembly that allows the organization of both magnetic and non-magnetic items while, at the same time, being functionally and aesthetically customizable.

To address these concerns, some companies have manufactured wall mounting structures to hold some of these household and commercial items. Wall mounts with built-in hooks, for example, may be securely attached to various wall surfaces to hook or hold various components such as kitchen utensils, retail displays, and construction tools. The user generally affixes the wall mount with bolts and screws and typically secures small items to the wall mount using the hook or other fastening device. Thus, these devices perform one single task and cannot organize items both magnetically and non-magnetically.

These mounting structures, however, lack versatility and generally result with damage to the surface. Such mounting structures, for instance, are usually permanently affixed to the surface, which generally results with damage due to hole drilling of the screws or other fasteners. Thus, once an organizer such as a conventional hook rack is screw mounted onto a wall, a user must justify the wall damage and allocation of space for its intended organizational task. As such, it would be preferable to a have an organizer that can handle various tasks or customize itself aesthetically, such that the user does not have to uninstall and reinstall new organizers. This would assist the user in saving a lot of effort and time while, at the same time, provide convenience to the user.

Additionally, these mounting structures are generally restricted to certain flat surface areas such as walls and ceilings and are often limited to holding small, light items due to their low weight carrying capacity characteristics. Specifically, the weight carrying capacity of these conventional products is generally very low due to their design. Accessories from these conventional products are usually flat and generally lack a second structural feature such as a “hood” that prevents magnetic devices from sliding. Without a hood, magnetic fasteners of most conventional products typically become strained when large items are hung. Thus, when a large product is hung on the hooks of these conventional products, the magnetic fasteners of these products slide off, as they are only capable of holding very light products. Rather than holding small items such as keys and rubber bands by conventional products, it would be preferable to have an organizer that utilizes a hood structure to assist the user in hanging items ten times larger than conventional products or items that are more than five pounds. A hood structure on these devices would preferably stop any sliding and would usually distribute the weight from any magnetic fasteners when large items are hung on the accessories. This would help satisfy various tasks such as holding large display signs on retail shelves at department stores; hang heavy bags, wheeled trollies, and bicycles along the cargo rails of semi-trucks; and hang large items along the edges of fridges and fridge doors. Preferably, the organizer will not require the use of a large magnet, but rather, a small portion of the magnets used by conventional products.

Moreover, most conventional organizers lack non-magnetic fasteners such as adhesive fasteners that possess a large carrying capacity and the ability to attach onto a non-metallic edge or ledge. Specifically, if magnets are utilized on the back of an organizer, those organizers must interact with a metallic surface in order to attach itself onto that surface. This, in turn, usually limits the use of that organizer for certain surfaces such as a wooden or plastic table, countertop, or shelf. Thus, it would be preferable to utilize adhesive fasteners, such that a user can utilize any surface as a dock for an accessory mount assembly and secure various accessories in a few seconds.

Finally, extra effort and labor is usually required when the user desires to replace these mounting structures. For example, in order to change the function of current organizational products, current products require the user to unscrew and reinstall screw fasteners in order to change the wall mounts completely. This is very time-consuming, and usually requires the user to purchase new mounting products and fasteners. As such, it would be preferable to have an organizer that allows a user to change a function in a few seconds. Otherwise, users would typically purchase additional products to accommodate these deficiencies.

Therefore, there is a need for an improved organizer that is versatile, customizable according to the needs of each user, and adaptable to various environments. Preferably, the organizer includes accessory mount assemblies that may removeably attach to a fixture assembly or various surfaces (e.g., edges, ledges, and extension frames) and preferably has a large carrying capacity that would be capable of holding large, heavy items (e.g., racks, caddies, spice racks, bicycles, travel bags, backpacks, chainsaws, roller trollies, etc. . . . ). Additionally, these accessory mount assemblies would preferably include fastening mechanisms that provides both magnetic and nonmagnetic organization of products and would allow a user to simply replace the accessory mount assemblies effortlessly in one to two seconds when changing their functions. Furthermore, utilizing multiple units of the organizer and accessory mount assembly in a single dwelling would typically allow the user to maximize the organizer's full potential (e.g., accessories from a kitchen may be used in a garage, closet, and vice versa). The accessory mount assembly of the customizable organizer would preferably be versatile, powerful, cost effective to manufacture, easy to install, and possess a large weight carry capacity characteristic.

### BRIEF SUMMARY OF THE INVENTION

To minimize the limitations in the cited references, and to minimize other limitations that will become apparent upon reading and understanding the present specification, the present invention discloses a new and useful customizable organizer assembly.

One embodiment of the present invention is a customizable organizer assembly, comprising: a fixture assembly; and one or more accessory mount assemblies; wherein said fixture assembly comprises of a fixture housing and one or more first fasteners; wherein said one or more accessory mount assemblies comprise: an accessory mount housing, an accessory, a hood, and one or more second fasteners; wherein said fixture assembly is configured to attach onto a surface; wherein said accessory performs at least one organizational function; wherein said hood is an upper portion of said each of said one or more accessory mount assemblies; and wherein said one or more first fasteners are configured to matingly engage with said one or more second fasteners to allow said one or more accessory mount assemblies to removeably attach to said fixture assembly. The fixture assembly may further comprise of a faceplate; wherein said faceplate may beattached to said fixture housing; wherein said faceplate may include at least one of said one or more first fasteners; wherein said at least one of said one or more first fasteners of said faceplate may be configured to contact said one or more second fasteners of said one or more accessory mount assemblies, such that said one or more accessory mount assemblies removeably attach to said fixture assembly. The fixture housing may comprise of a hood receiver; wherein said hood receiver may be an upper portion of said fixture assembly; and wherein said one or more accessory mount assemblies may matingly engage with said fixture assembly, such that said one or more first fasteners matingly engage with one or more second fasteners and said hood receiver supports said hood. The fixture housing may comprise of a hood receiver and a base receiver; wherein said hood receiver may be an upper portion of said fixture assembly; wherein said base receiver may be a lower portion of said fixture assembly; wherein each of said one or more accessory mount assemblies may be comprised of a base; wherein said base may be a lower portion of said each of said one or more accessory mount assemblies; and wherein said one or more accessory mount assemblies may removeably engage with said fixture assembly, such that said hood matingly engages with said hood receiver and said base matingly engages with said base receiver, such that said fixture assembly supports said one or more accessory mount assemblies. The base receiver of said fixture housing may be a snug-fit base receiver; wherein said one or more accessory mount assemblies may be one or more snug-fit accessory mount assemblies, such that said base of said one or more accessory mount assemblies is a snug-fit base; and wherein said one or more snug-fit accessory mount assemblies may removeably and matingly engage with said fixture assembly, such that said snug-fit base engages with said snug-fit base receiver. The hood receiver of said fixture assembly may be a trench-hood receiver; wherein said hood of said one or more accessory mount assemblies may be a trench-hood; and wherein said trench-hood may be configured to matingly engage with said trench-hood receiver, such that said fixture assembly substantially secures said one or more accessory mount assemblies. The hood receiver of said fixture assembly may be a curved-hood receiver; wherein said hood of said one or more accessory mount assemblies may be a curved-hood; and wherein said curved-hood may be configured to matingly engage with said curved-hood receiver, such that said fixture assembly supports with reduced slippage said one or more accessory mount assemblies. The customizable organizer assembly may comprise of a bin assembly; wherein said fixture assembly may comprises of a bin receiver; and wherein said bin assembly may removeably engage with said bin receiver of said fixture assembly. The customizable organizer assembly may further comprise a cover assembly; wherein said cover assembly may comprise of a hood and a base; wherein said fixture assembly may comprises of a cover receiver and base receiver; wherein said hood of said cover assembly may removeably engages with said cover receiver of said fixture assembly; and wherein said base of said cover assembly may removeably engage with said base receiver of said fixture assembly. The customizable organizer assembly may further comprise of one or more extensions; wherein a first end of said one or more extensions may be attached to said surface; and wherein a second end of said one or more extensions may be attached to said fixture assembly, such that said fixture assembly is secured to and extended from said surface. The customizable organizer assembly may further comprise of one or more extension mounting brackets and one or more extensions; wherein said one or more extension mounting brackets may be attached to said surface; wherein a first end of said one or more extensions may be attached to said one or more extension mounting brackets; and wherein a second end of said one or more extensions may be attached to said fixture assembly, such that said fixture assembly is secured to and extended from said surface. The said one or more extensions may be selected from the group consisting of: a hanger; a bar; and an L-shaped bracket. The one or more accessory mount assemblies may be one or more bracket-shaped accessory mount assemblies. The one or more accessory mount assemblies may be one or more L-shaped accessory mount assemblies.

Another embodiment of the present invention is a customizable organizer assembly, comprising: one or more accessory mount assemblies; wherein said one or more accessory mount assemblies comprise of: at least one accessory mount housing; at least one hood; one or more second fasteners; and at least one accessory; wherein said one or more second fasteners is configured to removeably attach to one or more surfaces, such that said one or more accessory mount assemblies removeably attach to said one or more surfaces; wherein said at least one hood is configured to contact a second surface, such that said at least one hood supports said one or more accessory mount assemblies; and wherein said at least one accessory performs at least one organizational function and holds and stores one or more items. The one or more second fasteners may be one or more magnets; wherein said one or more surfaces may be one or more metal surfaces, such that said one or more accessory mount assemblies removeably attach to said one or more surfaces. The one or more second fasteners may be one or more metals; wherein said one or more surfaces may include at least one magnet, such that said one or more accessory mount assemblies removeably attach to said one or more surfaces. The one or more second fasteners may be one or more adhesive fasteners; wherein said one or more surfaces may include at least one of said one or more adhesive fasteners attached to said one or more surfaces, such that said one or more accessory mount assemblies removeably attach to said one or more surfaces. The one or more second fasteners may be permanently attached to said one accessory mount housing. The one or more second fasteners may be detachable from said one accessory mount housing. The at least one accessory may be permanently attached to said one accessory mount housing. The at least one accessory may be detachable from said one accessory mount housing. The one or more accessory mount assemblies may further comprise of one or more upper finger grips; wherein said one or more upper finger grips may be located at an upper portion of said one or more accessory mount assemblies; and wherein said one or more upper grips may be configured to assist a user to dismount said one or more accessory mount assemblies from said one or more surfaces. The one or more accessory mount assemblies may further comprise of one or more lower finger grips; wherein said one or more lower finger grips may be located at a lower portion of said one or more accessory mount assemblies; and wherein said one or more lower grips may be configured to assist a user to dismount said one or more accessory mount assemblies from said one or more surfaces. The one or more surfaces may be edges of one or more utility carts, such that said one or more accessory mount assemblies removeably attach to said one or more utility carts; and wherein said organizational function may be to hold and store one or more items. The one or more surfaces may be one or more magnetic knife holders and one or more magnetic tool holders, such that said one or more accessory mount assemblies removeably attach to said one or more magnetic knife holders and one or more magnetic tool holders. The one or more surfaces may be edges of one or more retail display equipment of a store such that said one or more accessory mount assemblies may removeably attach to said one or more retail display equipment of said store; wherein said one or more retail display equipment may be selected from the group consisting of: a shelf; a refrigerator; a standing sign; and a store rack; wherein said at least one accessory may be selected from the group consisting of: a hook; a hanger; a rack; a display; a sign holder; a sign; a tray; a shelf; and wherein said organizational function of said one or more accessory mount assemblies may be selected from the group consisting of: organizing one or more items; displaying one or more prices; displaying one or more advertisements; displaying one or more promotions; and displaying one or more products. The one or more surfaces may be edges of one or more storage shelves, such that said one or more accessory mount assemblies removeably attach to said one or more storage shelves; and wherein said one or more storage shelves in combination with said one or more accessory mount assemblies may become said customizable organizer assembly to hold and store one or more items and to organize said one or more items. The one or more surfaces may be edges of one or more metal beams and one or more metal frames of a semi-truck, such that said one or more accessory mount assemblies removeably attach to said one or more metal beams and one or more metal frames of a semi-truck; and wherein said organizational function may be to hold and store one or more items hang one or more items. The one or more surfaces may be one or more edges of an assembly line workspace in a factory, such that said one or more accessory mount assemblies removeably attach to said one or more edges of said assembly line workspace in said factory; and wherein said organizational function may be to hold and store one or more items. The one or more surfaces may be one or more walls of a cubicle of an office building, such that said one or more accessory mount assemblies removeably attach to said one or more walls of said cubicle of said office building; and wherein said organizational function may be to hold and store one or more items. The one or more surfaces may be one or more filing cabinets, such that said one or more accessory mount assemblies removeably attach to said one or more filing cabinets; and wherein said organizational function may be to hold and store one or more items. The one or more surfaces may be one or more workspaces of a tooling shop, such that said one or more accessory mount assemblies removeably attach to said one or more workspaces of said tooling shop using said one or more second fasteners; and wherein said organizational function may be to hold and store one or more items.

Another embodiment of the present invention is a customizable organizer assembly, comprising: a fixture assembly; and one or more accessory mount assemblies; wherein the fixture assembly comprises of a fixture housing, a faceplate, a hood receiver; and one or more first fasteners; wherein the faceplate is attached to the fixture housing; wherein the hood receiver is an upper portion of the fixture assembly; wherein the faceplate includes at least one of the one or more first fasteners; wherein the fixture housing is configured to attach onto a surface; wherein each of the one or more accessory mount assemblies comprises of: an accessory mount housing, a hood, an accessory, and one or more second fasteners; wherein the hood is an upper portion of the each of the one or more accessory mount assemblies; wherein the accessory removeably attaches to the accessory mount housing; wherein the accessory performs an organizational function; wherein the one or more second fasteners are positioned at a rear portion of the accessory mount housing; and wherein the one or more accessory mount assemblies removeably engages with the fixture assembly, such that the hood matingly engages the hood receiver and the one or more second fasteners matingly engage with the one or more first fasteners. The faceplate may be configured to include one or more texts and one or more graphics. The fixture housing may comprise of a base receiver; wherein the one or more accessory mount assemblies may comprise of a base; wherein the base receiver may be a lower portion of the fixture assembly; wherein the base may be a lower portion of the one or more accessory mount assemblies; and wherein the one or more accessory mount assemblies may removeably engage with the fixture assembly, such that the base may matingly engage with the base receiver, such that the fixture assembly may support the one or more accessory mount assemblies. The base receiver of the fixture housing may be a snug-fit base receiver; wherein the one or more accessory mount assemblies may be one or more snug-fit accessory mount assemblies, such that the base of the one or more accessory mount assemblies may be a snug-fit base; and wherein the one or more snug-fit accessory mount assemblies may removeably and matingly engage with the fixture assembly, such that the snug-fit base may engage with the snug-fit base receiver. The customizable organizer assembly hood receiver of the fixture assembly may be a trench-hood receiver; wherein the hood of the one or more accessory mount assemblies may be a trench-hood; and wherein the trench-hood may be configured to matingly engage with the trench-hood receiver, such that the fixture assembly may substantially secure the one or more accessory mount assemblies. The hood receiver of the fixture assembly may be a curved-hood receiver; wherein the hood of the accessory mount assemblies may be a curved-hood; and wherein the curved-hood may be configured to matingly engage with the curved-hood receiver, such that the fixture assembly may support with reduced slippage the one or more accessory mount assemblies. The customizable organizer assembly may further comprise a bin assembly; wherein the bin assembly may comprises of a bin receiver, one or more second fasteners, and one or more third fasteners; wherein the bin assembly may removeably engage with the bin receiver of the fixture assembly and the one or more second fasteners of the bin assembly may matingly engage with the one or more first fasteners of the fixture assembly, such that the one or more third fasteners of the bin assembly may be exposed and configured for attaching the one or more second fasteners of the one or more accessory mount assemblies to the bin assembly. The customizable organizer assembly may further comprise a cover assembly; wherein the cover assembly may comprises of a hood, a base, a hood receiver, and a base receiver; wherein the fixture assembly may comprises of a cover receiver and base receiver; wherein the hood of the cover assembly may removeably and matingly engage with the cover receiver the fixture assembly; wherein the base of the cover assembly may removeably and matingly engage with the base receiver of the fixture assembly; wherein the hood receiver of the cover assembly may be configured to matingly engage with the hood of the one or more accessory mount assemblies; and wherein the base receiver of the cover assembly may be configured to matingly engage with a base of the one or more accessory mount assemblies. The customizable organizer assembly may further comprise one or more extensions; wherein a first end of the one or more extensions may be attached to the surface; and wherein a second end of the one or more extensions may be attached to the fixture assembly, such that the fixture assembly may be secured to and extended from the surface. The customizable organizer assembly may further comprise one or more extension mounting brackets; wherein the one or more extension mounting brackets may be attached to the surface; wherein a first end of the one or more extensions may be attached to the one or more extension mounting brackets; and wherein a second end of the one or more extensions may be attached to the fixture assembly, such that the fixture assembly may be secured to and extended from the surface. The one or more extensions may be selected from the group consisting of: a hanger; a bar; and an L-shaped bracket. The one or more accessory mount assemblies may further comprise of an upper grip and lower grip; and wherein the upper grip and the lower grip may be configured to assist the user to dismount the one or more accessory mount assemblies. The one or more accessory mount assemblies may be utilized with one or more detachable accessory assemblies. The one or more accessory mount assemblies may be bracket-shaped accessory mount assemblies. The one or more accessory mount assemblies may be one or more L-shaped accessory mount assemblies.

Another embodiment of the present invention is a customizable organizer assembly, comprising: one or more accessory mount assemblies; wherein the one or more accessory mount assemblies comprise: an accessory mount housing, one or more fasteners, and an accessory; wherein the one or more accessory mount assemblies are configured to removeably attach onto a surface by the one or more fasteners; and wherein the accessory performs at least one organizational function.

It is an object of the present invention to provide an organizer assembly that is customizable and readily adaptable to a wide variety of different applications without structural modification.

It is another object of the present invention to provide an accessory mount assembly that is a “versatile organizer” in that the accessory mount assembly is capable of hanging more than five pounds without using a giant magnet (e.g., a magnet with the size of two thumbs put together). The accessory mount assembly will preferably have a high weight carrying to carry much more weight in order to serve numerous tasks, and do real work rather than hanging small items such as keys and rubber bands. The present invention will preferably function as sign holders for retail shelves at department stores; hang big heavy bags, wheeled trollies, and bicycles along semi-trucks cargo rails; removeably hang medium sized spice racks in kitchens, big point-of-sale display racks in retail stores on their shelves; and hang large items along the edges of their fridges and fridge doors. Preferably, the present invention utilizes magnets that are approximately one-tenth of the magnets used by conventional organizational products and are preferably configured to have a weight carrying-capacity that is at least ten times greater than conventional organizational products.

It is another object of the present invention to provide a customizable organizer assembly that utilizes adhesives to attach a receiving member (e.g., magnet or hook and loop fastener such as Velcro®) to edges or ledges. Specifically, if magnets for organizers are attached to the back of the accessory mount assemblies, those accessory mount assemblies must then interact with a metallic surface in order to attach itself thereon. This generally limits magnetic hooks interactions if a table, countertop, or shelf is wooden or plastic. By attaching a receiving member (ex. magnet or hook and loop fastener such as Velcro®) along the edge or ledge of an object using adhesives, that edge or ledge is preferably ready to accept the accessory mount assembly. This installation generally does not require screw fasteners, and can be completed in less than ten seconds. Preferably, the adhesive fasteners of the accessory mount assembly is easy to peel and easy to stick. This edge or ledge would preferably be able to removeably attach an accessory mount assembly, and users may easily peel off the receiving member when they want to change locations.

It is another object of the present invention to transform any surface into a receiver for the accessory mount assembly to dock onto, no matter if the surface is made of wood or plastic.

It is another object of the present invention to provide an organizer assembly that utilizes a variety of fastening devices when customizing according to the user's preferences.

It is another object of the present invention to provide a universal organizer that is versatile, powerful, cost-effective to manufacture, and effortlessly easy to use.

It is an object of the present invention to overcome the limitations of the prior art.

Other features and advantages are inherent in the customizable organizer assembly claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of the customizable organizer assembly.

FIG. 2 is an illustration of one embodiment of the fixture assembly.

FIG. 3 is an illustration of another embodiment of the fixture assembly and shows the fixture assembly with a trench-hood receiver

FIG. 4 is a side-view illustration of another embodiment of the fixture assembly and trench accessory mount assembly and shows the trench accessory mount assembly engaging with the fixture assembly.

FIG. 5 is an illustration of another embodiment of the fixture assembly and shows the fixture assembly with a curved-hood receiver.

FIG. 6 is a side-view illustration of another embodiment of the fixture assembly and curved-hood accessory mount assembly and shows the curved-hood accessory mount assembly engaging with the fixture assembly.

FIG. 7 is an illustration of another embodiment of the fixture assembly.

FIG. 8 is a side-view illustration of another embodiment of the fixture assembly and snug-fit accessory mount assembly and shows the snug-fit accessory mount assembly engaging with the fixture assembly with a snug-fit base receiver.

FIG. 9 is an illustration of another embodiment of the fixture assembly with a bin assembly.

FIG. 10 is an illustration of another embodiment of the fixture assembly with a bin receiver and shows the fixture assembly without the bin assembly.

FIG. 11 is an illustration of another embodiment of the bin assembly and third fastener and shows the third fastener engaging with the bin assembly.

FIG. 12 is an illustration of another embodiment of the fixture assembly and bin assembly and shows the bin assembly engaging with the fixture assembly

FIG. 13 is an illustration of another embodiment of the fixture assembly with a cover assembly.

FIG. 14 is an illustration of one embodiment of a cover assembly.

FIG. 15 is an illustration of another embodiment of the fixture assembly with hangers.

FIG. 16 is an illustration of another embodiment of the fixture assembly with bars.

FIG. 17 is an illustration of another embodiment of the fixture assembly with an L-shaped bracket.

FIG. 18 is an illustration of one embodiment of an accessory mount assembly.

FIG. 19 is an illustration of one embodiment of a bracket-shaped accessory mount assembly.

FIG. 20 is an illustration of one embodiment of an L-shaped accessory mount assembly.

FIG. 21 is an illustration of one embodiment of a snug-fit accessory mount assembly.

FIG. 22 is an illustration of one embodiment of a trench accessory mount assembly.

FIG. 23 is an illustration of one embodiment of a curved-hood accessory mount assembly.

FIG. 24 is an illustration of one embodiment of an accessory mount assembly with a bin assembly and shows how the bin assembly engages with the accessory mount assembly.

FIG. 25 is an illustration of one embodiment of an accessory mount assembly with a detachable accessory assembly.

FIG. 26 is an illustration of another embodiment of the customizable organizer assembly and shows the fixture assembly with two accessory mount assemblies.

FIG. 27 is an illustration of another embodiment of the L-shaped accessory mount assembly and shows the L-shaped accessory mount assembly attached to a metallic edge.

FIG. 28 is an illustration of another embodiment of two L-shaped accessory mount assemblies magnetically attached to a metallic edge of an object.

FIG. 29 is an illustration of another embodiment of the L-shaped accessory mount assembly and shows the accessory mount assembly with the accessory as a rectangular shaped container.

FIG. 30 is an illustration of another embodiment of the L-shaped accessory mount assembly and shows the accessory mount assembly with the accessory as two hanger bars.

FIG. 31 is an illustration of another embodiment of the L-shaped accessory mount assembly and shows the accessory mount assembly with the accessory as a shelf.

FIG. 32 is an illustration of another embodiment of the L-shaped accessory mount assembly and shows the accessory mount assembly with magnets.

FIG. 33 is an illustration of another embodiment of the L-shaped accessory mount assembly with an adhesive fastener beneath the hood and shows how the accessory mount assembly attaches to an edge with the adhesive fastener underneath the hood.

FIG. 34 is an illustration of another embodiment of the L-shaped accessory mount assembly with an adhesive fastener on its rear side and shows how the accessory mount assembly attaches to an edge with the adhesive fastener through the rear side.

FIG. 35 is an illustration of one embodiment of the fixture assembly and shows the faceplate with texts and graphics.

FIG. 36 is an illustration of one embodiment of the accessory mount assembly and shows the accessory mount assembly attached to a utility cart.

FIG. 37 is an illustration of additional embodiments of the accessory mount assembly and shows the accessory mount assemblies attached to a retail display equipment of a retail store.

FIG. 38 is an illustration of one embodiment of the accessory mount assembly and shows the accessory mount assembly attached to a storage shelf.

FIG. 39 is an illustration of additional embodiments of the accessory mount assembly and shows the accessory mount assemblies attached to a metal beam and metal frame of a semi-truck.

FIG. 40 is an illustration of additional embodiments of the accessory mount assembly and shows the accessory mount assemblies attached to a roller cabinet.

FIG. 41 is an illustration of additional embodiments of the accessory mount assembly and shows the accessory mount assemblies attached to a filing cabinet.

FIG. 42 is an illustration of additional embodiments of the accessory mount assembly and shows the accessory mount assemblies attached to a wall of a cubicle and onto a ledge of a desk.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “fastener”, “fastening mechanism”, “first fastener”, “second fastener”, “third fastener”, “cover fastener”, and “utility member” generally refer to any device that mechanically joins or affixes two or more objects together including, without limitation, magnets, metals, metallic plates, adhesives, adhesive strips, ultrasonic welding, adhesive strips, fastener strips, hook and loop fasteners, threaded fasteners such as screws and bolts, rivets, clamps, clips, button fasteners, Velcro®, Velcro® strips, Velcro®-like strips, and the like. Preferably, the first fastener is used on the fixture assembly, but may be utilized with other components of the customizer organizer assembly, such that the first fastener may interact with either a second fastener or third fastener. Preferably, the second fastener is utilized on the accessory mount assembly, but may also be used on other components of the customizer organizer assembly (e.g., bin assembly and cover assembly), such that the second fastener may interact with either a first fastener or third fastener. Preferably, the third fasteners are located on the bin assembly for the accessory mount assembly or bin assembly for the fixture assembly but may be used on other components, such that the third fastener may interact with either the first fastener or second fastener. As such, the fastener may be utilized in the following objects or components, without limitation, fixture assemblies, accessory mount assemblies, including at least bracket-shaped accessory mount assemblies and L-shaped accessory mount assemblies, faceplates, bin receiver, bin assembly, cover receiver, cover assembly, extensions, including at least hangers, bars, L-shaped brackets), and the like.

The terms “button fastener”, “button member”, and “button receiver” preferably refer to one or more fasteners that comprise of at least one compressible button and at least one hole or slot that mate or engages with that compressible button. Specifically, a user typically presses the button of a first object and preferably slides the button into the hole or slot of a second object. The button then generally springs back into its original position, such that the button becomes preferably trapped or secured in the designated hole or slot. As a result, the button preferably attaches or secures the first object to the second object and preferably restricts or prohibits any movement from both objects. To release the first object from the second object, the user preferably compresses the button and slides the button out from their respective hole or slot.

The term “spring” generally refers to any elastic device, such as a coil of wire, that regains its original shape after being compressed or extended and is preferably used for the button fasteners.

The terms “fastener slot” and “utility slots” preferably refer to any space or slot that may be used to house or secure one or more fasteners including, without limitation, first fasteners, second fasteners, third fasteners, cover fasteners, threaded fasteners (including, but not limited to, screws, bolts, and threaded screw holes), button fasteners, magnets, metals, metallic plates, adhesives, adhesive fasteners, fastener strips, hook and loop fasteners, rivets, clamps, Velcro®, Velcro® strips, Velcro®-like strips, and clips. A fastener slot may be included inside or outside of an object or component (including, but not limited to, fixture assemblies, accessory mount assemblies such as bracket-shaped accessory mount assemblies and L-shaped accessory mount assemblies, bin receiver, bin assembly, cover receiver, cover assembly, extensions such as hangers, bars, L-shaped brackets, and the like). The fasteners may also be generally secured within the fastener slot by some mechanism (including, but not limited to, screws/bolts/fasteners, glue, cement, button fasteners, etc.).

The terms “accessory” and “accessory member” generally refer to any device that performs a specialized or organizational task including, without limitation, hooks, hanger bars, racks, shelves, containers, bags, boxes, pouches, receivers, magnets, timers, displays, sign holders, signs, electronic devices (including but not limited to, timers, clocks, thermometers, pH readers, electronic displays, and hygrometers), and the like.

The term “item” generally refers to an individual article or unit used for the customizable organizer assembly including, without limitation, wires; wrenches; ropes; rags; cloths; bags; trollies; bicycles; ropes; helmets; racks; organizers; clothing; scarves; laptop bags; backpacks; paper files; office supplies; tapes; lunchboxes; belts; keys; scissors; rulers; pencils; umbrellas; and the like. The term “tool” generally refers to any device used to perform or facilitate manual or mechanical work, including without limitation, wrenches; wires; nuts; bolts; screws; tapes; helmets; gloves and the like.

The terms “assembly line workspace” and “assembly line” generally refer to an arrangement of machines, equipment, and workspace in which one or more products being assembled passes consecutively from operation to operation until completed, including without limitation machines, machinery, conveyors, conveyor belts, furniture, metal furniture (e.g., metal desks, metal tables, etc. . . . ), and the like.

The present invention is preferably a customizable organizer assembly that allows a user to organize accessories in a home or workspace by mounting or attaching various accessory mount assemblies to a fixture assembly or other object. For example, the customizable organizer assembly may function as a clothing rack by mounting and securing the fixture assembly on a wall and attaching an accessory mounting assembly with hooks to the mounted fixture assembly to hang clothing. Once the clothing rack is no longer needed, the user may reorganize the customizable organizer assembly by simply detaching the accessory mount assembly from the fixture assembly and reattaching another embodiment of the accessory mount assembly for a different purpose. Each accessory mount assembly may include an accessory that functions as a different tool such as a hook, hanger, container, timer, thermometer, or weather display that the user may use within his or her workspace or living space.

### General Overview of the Customizable Organizer Assembly

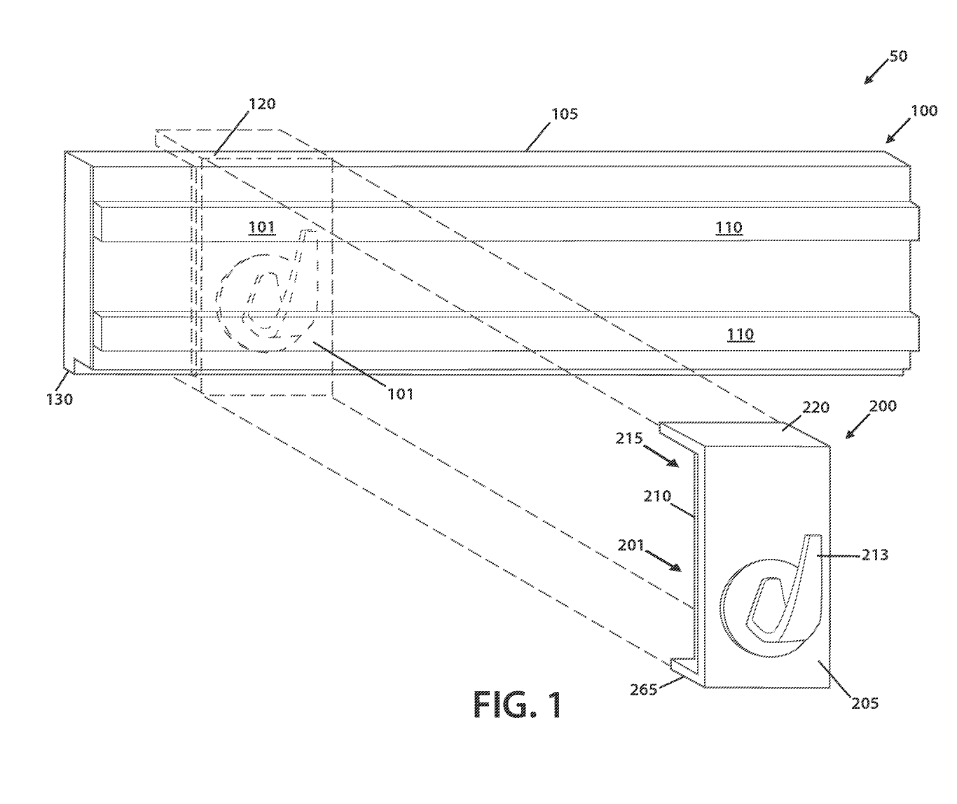

FIG. 1 is an illustration of one embodiment of the customizable organizer assembly. As shown in FIG. 1, the customizable organizer assembly 50 preferably includes: a fixture assembly 100 and an accessory mount assembly 200. The fixture assembly 100 is preferably any structure or plurality of parts configured to be attached to and/or secured onto a substantially stationary surface of a home, building, or vehicle such as wall or ceiling and preferably includes a fixture housing 105 and one or more first fasteners 110. For example, the fixture housing 105 may be directly attached onto a surface such as a wall or ceiling, or alternatively, attached to various building extensions such as doors, barriers, machines, appliances, tables, counters, shelves, stands, and the like. Alternatively, the fixture housing 105 may also function unattached to a wall or object, such that the customizable organizer assembly 50 acts as an independent organizational device—e.g., the customizable organizer assembly 50 may be placed on a table, countertop, or shelf, rather than, being mounted onto a wall or surface.

As discussed above, the first fastener 110 is preferably any device that mechanically or magnetically joins or affixes two or more objects together. The first fastener 110 preferably comprises, in combination with the fixture assembly 100, a first contact surface 101, which is preferably one or more surfaces that contacts with the accessory mount assembly 200. The first fastener 110 may include, without limitation, magnets, metals, metallic plates, adhesives, fastener strips, hook and loop fasteners, such as Velcro®, threaded fasteners (including, but not limited to, screws and bolts, threaded holes), rivets, clamps, clips, and the like. Preferably, the first fasteners 110 and second fastener 210 are male and female fasteners, such that the first fastener 110 removeably mates or engages with the second fastener 210. Each fixture assembly 100 may contain one or more first fasteners 110, and may contain any combination of first fasteners 110 (including magnets, metallic plates, adhesive members, and the like).

The accessory mount assembly 200 is preferably any device that is configured to fasten onto the fixture assembly 100 or other objects (including, but not limited to, tables, workbenches, countertops, machines, shelves, stands, etc. . . . ) and preferably includes an accessory mount housing 205; second fastener 210; accessory 213; hood 220; and a second contact surface 201. The accessory mount assembly 200 may also further comprise of a base 265. As discussed above, the accessory 213 is preferably a device or object configured to perform a specialized task and may include, without limitation, hooks, hanger bars, shelves, racks, containers, trays, bags, boxes, magnets, timers, displays, sign holders, signs, electronic devices, and the like. The second faster 210, also as discussed above, is preferably any device that mechanically joins or affixes two or more objects together including, without limitation, magnets, metals, metallic plates, adhesives, adhesive strips, button fasteners, fastener strips, snap lock strips, hook and loop fasteners, Velcro®, Velcro®-like fastener strips, threaded fasteners such as screws and bolts, rivets, clamps, and clips.

The accessory mount assembly 200 may be relatively short (e.g., lengthwise) so as to have a single accessory 213 on it such as a hook, or the accessory mount assembly 200 may be relatively long (e.g., horizontal or vertical) so as to have a plurality of accessories on it. Additionally, the accessory mount assembly 200 may vary in length, height, and shape, and each accessory mount assembly 200 may contain a single accessory 213 or multiple accessories. Furthermore, the accessory 213 may be permanently attached to the accessory mount assembly 200 or may be removable or detachable from the accessory mount assembly 200.

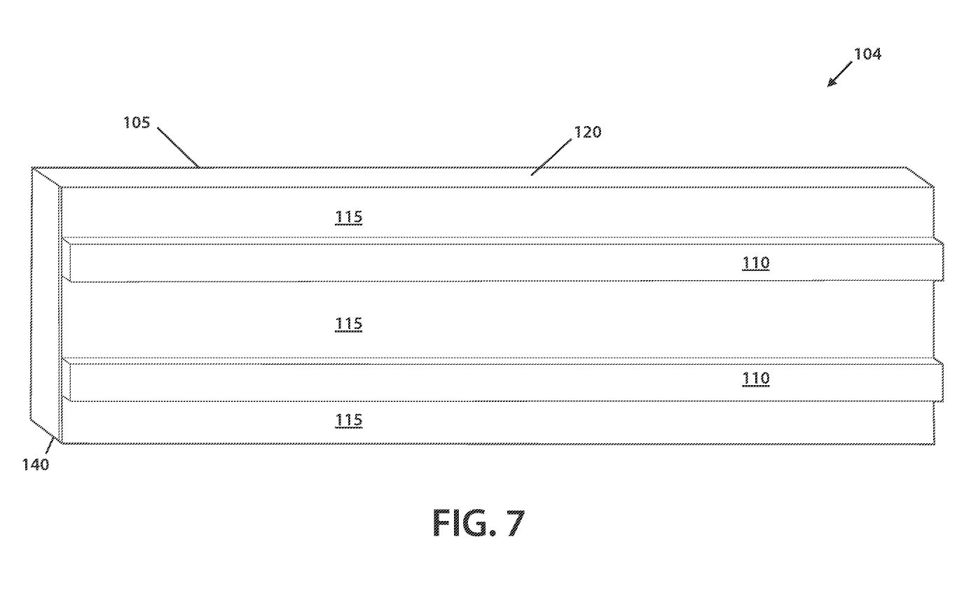

Each accessory mount assembly 200 generally includes a hood 220, which preferably mates with the hood receiver 120 of the fixture assembly 100, and may include a base 265, which preferably mates with the base receiver 130 of the fixture assembly 100. Additionally, each accessory mount assembly 200 may have a second contact surface that preferably contacts or interacts with the first contact surface 101, such that the first fastener 110 of the fixture assembly 100 matingly engages with the second fastener 210 of the accessory mount assembly 200. Furthermore, the weight load of the accessory mount assembly 200 is also preferably shifted from the first and second fasteners to the hood 220 and hood receiver 120 instead. In various embodiments of the customizable organizer assembly 50, the hood 220 may configured as a trench-hood 910 or curved-hood 1005. The base 265 may also be configured in various embodiments such as a snug-fit base 805, and the fixture assembly may have a snug-fit base receiver 140 (shown in FIG. 7, 8).

### Part I

### Component Description of the Fixture Assembly

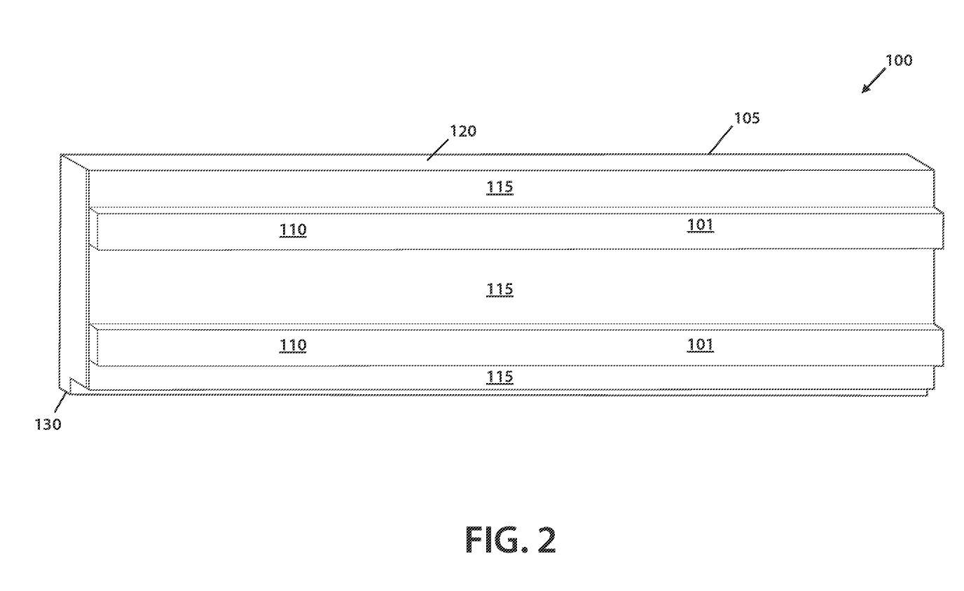

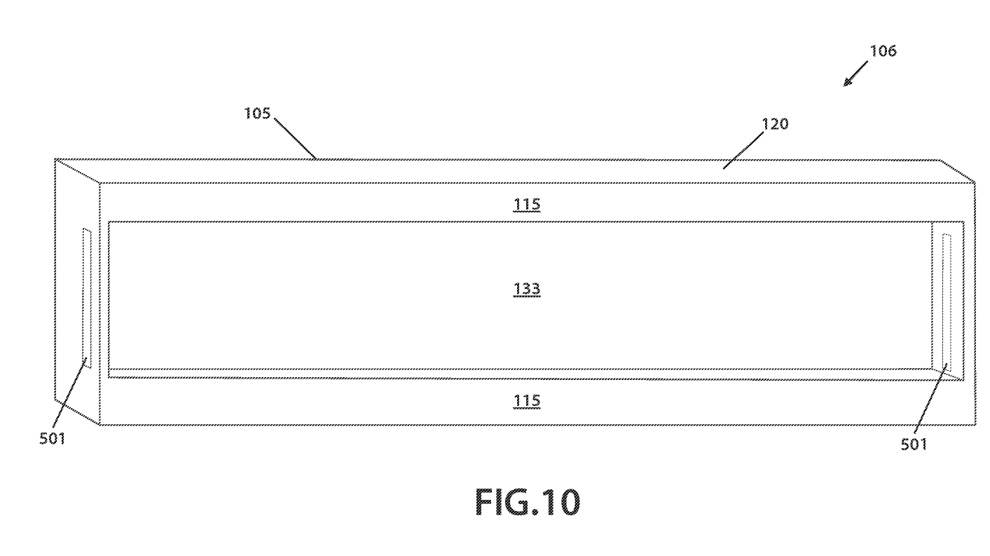

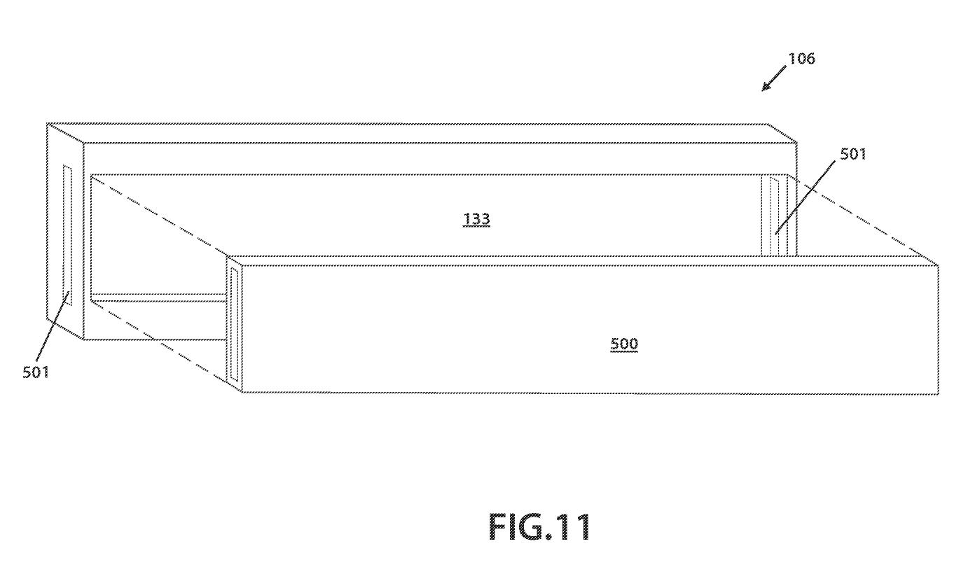

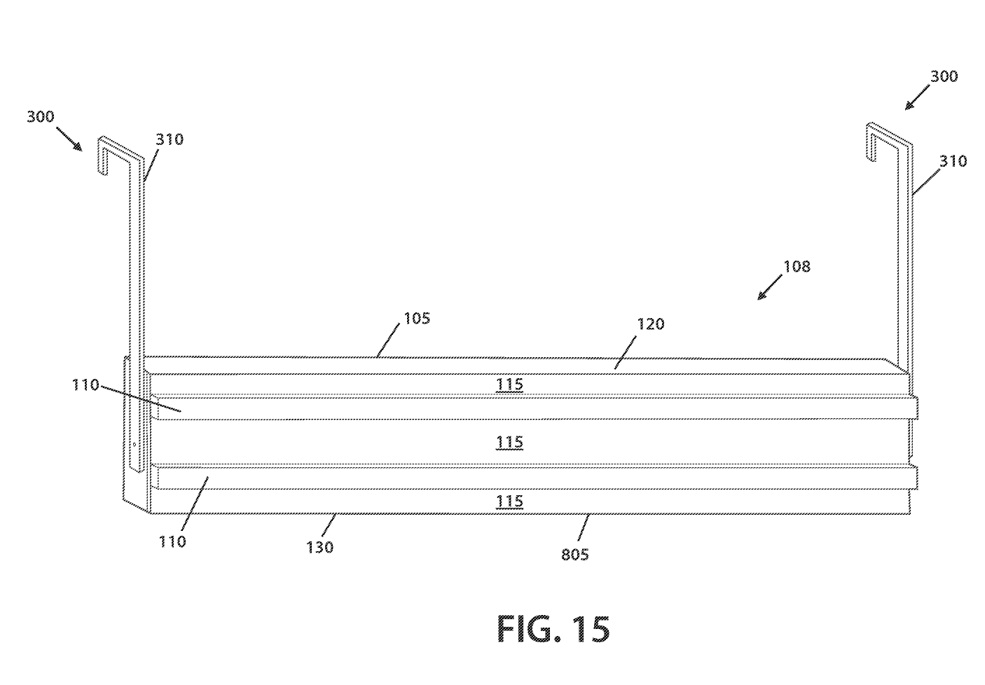

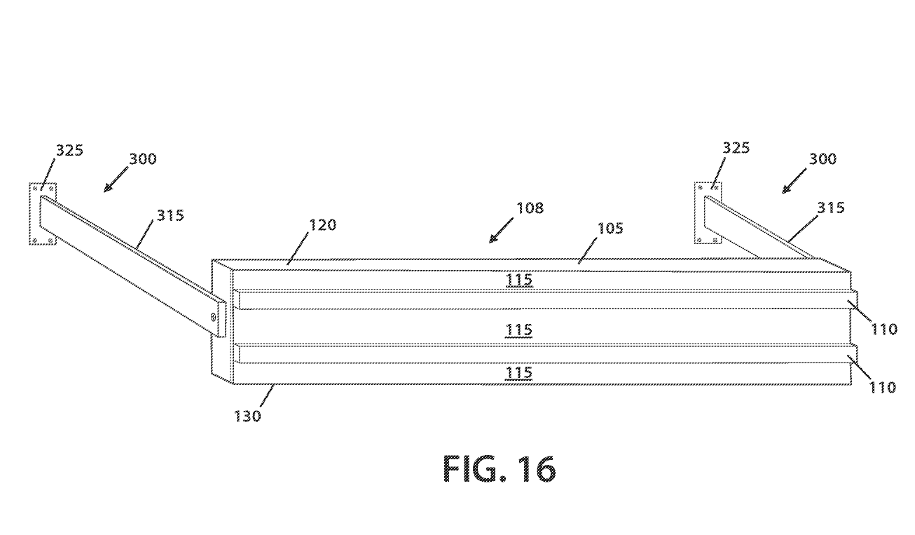

FIG. 2 is an illustration of one embodiment of the fixture assembly. As shown in FIG. 2, the fixture assembly 100 may include: one or more first fasteners 110; a faceplate 115; and fixture housing 105, wherein the fixture housing 105 preferably includes: a hood receiver 120; and base receiver 130. The fixture assembly 100 may also include other components such as a bin receiver 133 (shown in FIGS. 10 and 11); cover receiver; extensions 300; (shown in FIGS. 15, 16, 17); extension mounting brackets 325 (shown in FIG. 16); and snug-fit base receiver 140 (shown in FIG. 7, 8). Preferably, each fixture assembly 100 includes a first contact surface 101, wherein the first contact surface 101 preferably comprises of one or more first fasteners 110 or any combination thereof for attaching and securing the accessory mount assembly 200.

The fixture assembly 100 generally functions as a dock for mounting one or more accessory mount assemblies, each of which preferably has a different accessory 213 for performing a different task. Specifically, an accessory mount assembly 200 may attach to and secure onto the fixture assembly 100 when the first contact surface 101 of the fixture assembly 100 interacts with the second contact surface 201 of the accessory mount assembly 200.

Each fixture assembly 100 may contain a combination of first fasteners 110 for attaching and securing the accessory mount assembly 200 and may contain additional fasteners to attach the fixture assembly 100 directly to a surface or object. Additionally, extensions 300 may also be used to attach the fixture assembly 100 to a surface or other object.

First Contact Surface—

As discussed above, the first contact surface 101 is preferably one or more regions of the fixture assembly 100 comprising of a group of components or fasteners that are preferably configured to matingly engage with the second contact surface 201 of the accessory mount assembly 200. The first contact surface 101 is also preferably configured to allow the accessory mount assembly 200 to easily detach from the fixture assembly 100. In other words, the fixture assembly 100 and accessory mount assembly 200 may be firmly attached to each other, but, as preferred may be easily separated (and reattached) by the user. The first contact surface 101 is generally not a specific component or member of the fixture assembly 100 (although it can be) but rather, it is preferably a representation of one or more components of the fixture assembly 100 (e.g., first fasteners 110).

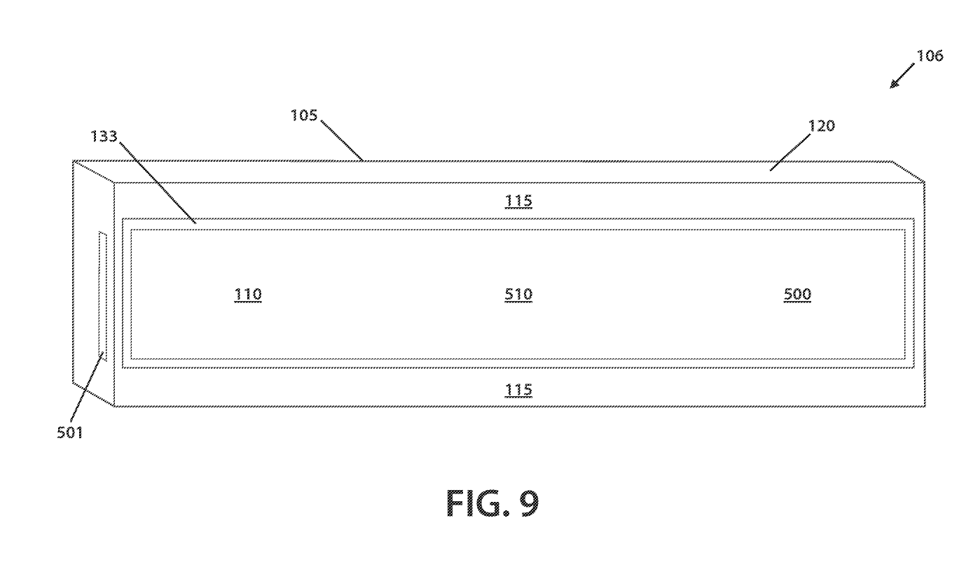

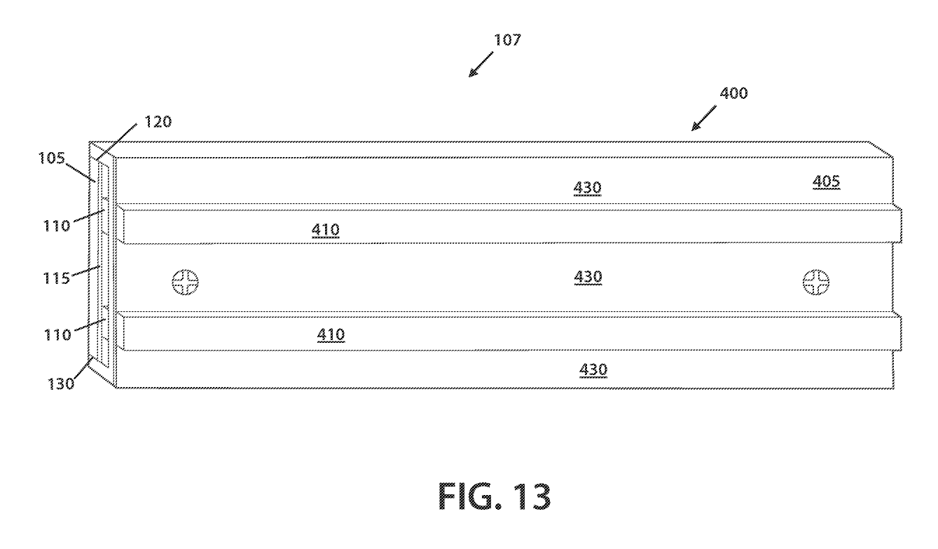

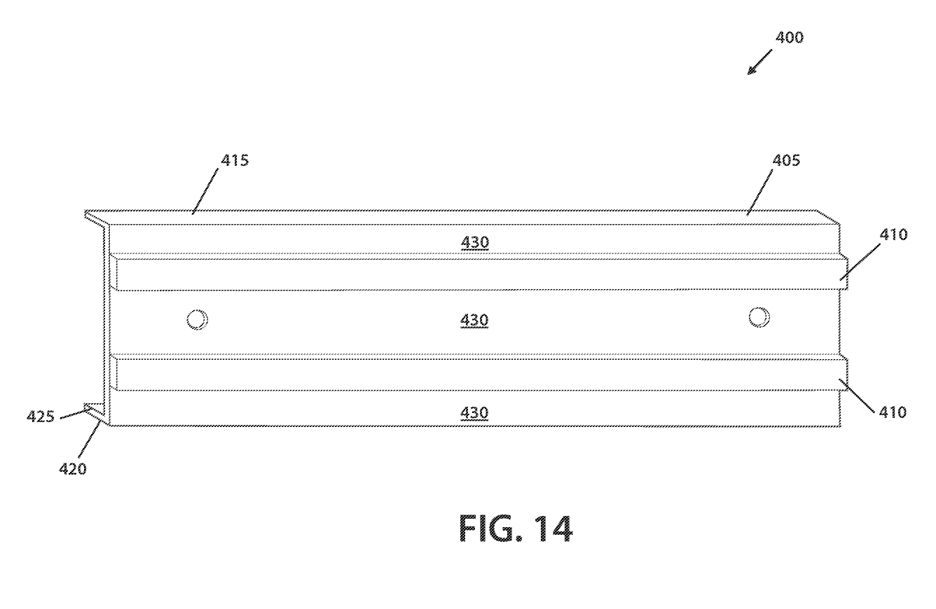

Examples of such components that generally comprise the first contact surface 101 may include, without limitation: a first fastener 110, bin assembly 500 (shown in FIGS. 9, 11, 12), cover assembly 400 (shown in FIGS. 13, 14), and faceplate 115. The first contact surface 101 of the fixture assembly 100 and second contact surface 201 of the accessory mount assembly 200 may be constructed in various sizes and shapes.

Fixture Housing—

The fixture housing 105 is preferably the main chassis or housing of the fixture assembly 100 and preferably houses, contains, and/or comprises all of the components associated with the fixture assembly 100.

Faceplate

The faceplate 115 is generally one or more pieces of metal, magnets, or portion of the fixture assembly 100 used to interact with the second contact surface 201 of the accessory mount assembly 200. The faceplate 115 may solely include magnets or may be constructed with metallic materials alone. For example, in a preferred embodiment, when utilizing the faceplate 115 constructed with magnetic fasteners, an accessory mount assembly 200 with metal surfaces alone is preferably configured to dock onto or attach to the faceplate 115 of the fixture assembly 100. Thus, due to the magnetic properties of the faceplate 115 in that embodiment, the faceplate 115 may function as a first fastener 110. It should be understood, however, that if the fixture assembly 100 lacks any magnets, the fixture assembly 100 may interact with the accessory mount assembly 200 that utilizes magnets, by utilizing a faceplate 115 with a metallic surface.

Furthermore, the faceplate 115 may comprise dual fastening combinations between a fixture assembly 100 and accessory mount assembly 200 (e.g., both the fixture assembly 100 and accessory mount assembly 200 utilize magnetic and metallic first fasteners 110). Specifically, a fixture assembly 100 having both magnetic and metallic first fasteners 110 may interact with an accessory mount assembly 200 utilizing both magnetic and metallic second fasteners 210. The magnetic first fasteners 110 of the fixture assembly 100 preferably interact with the metallic second fasteners 210 of the accessory mount assembly 200 while, at the same time, the magnetic second fasteners 210 of the accessory mount assembly 200 preferably interact with the metallic first fasteners 110 of the fixture assembly 100. Thus, dual fastening combinations preferably increase the carrying capacity performance of the accessory mount assembly 200.

Finally, in another embodiment, the faceplate 115 may serve as an artistic canvas of the fixture assembly 100. For example, the metallic faceplate 115 may include graphics, texts, engravings, and other artistic renderings that will provide a personality and artistic presence to each fixture assembly 100. Alternatively, the faceplate 115 may also be used as a marketing tool, to brand and commercialize different business logos, trademark texts, and licensed characters.

Hood Receiver

The upper or top portion of the fixture assembly 100, which is referred to as the hood receiver 120, preferably interacts with the upper portion of accessory mount assembly 200 or hood 220. The hood receiver 120 may have a variety of shapes (including, but not limited to, flat, round, trench, triangular, male, female.), and the shape and size of that hood receiver 120 preferably complements the shape and size of the hood 220 of the accessory mount assembly 200 to increase or maximize the carrying capacity of the accessory mount assembly 200. Furthermore, each fixture assembly 100 may have multiple hood receivers without deviating from the scope of the invention.

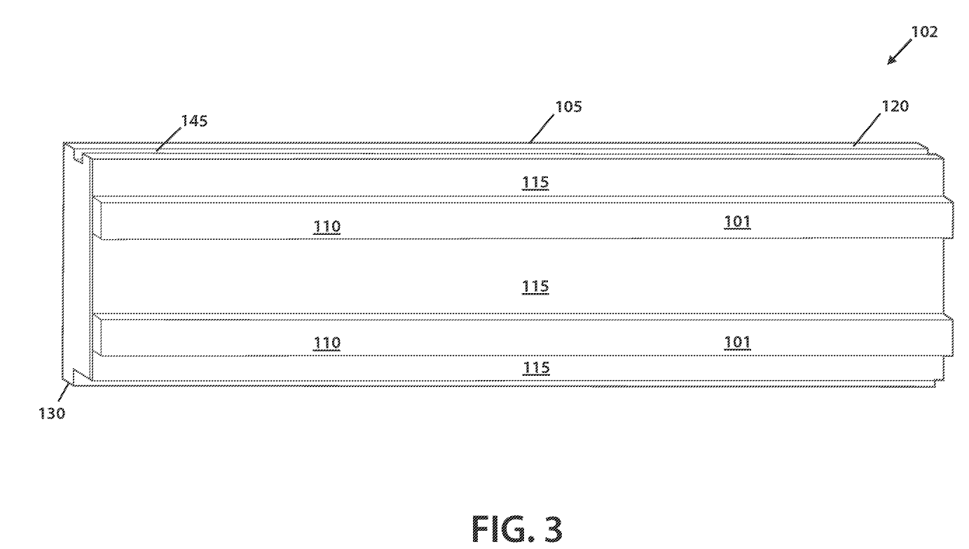

FIG. 3 is an illustration of another embodiment of the fixture assembly and shows the fixture assembly with a trench-hood receiver. As shown in FIG. 3, the fixture assembly 102 may include: one or more first fasteners 110; a faceplate 115; fixture housing 105, a trench-hood receiver 145; and base receiver 130.

Trench-hood Receiver—

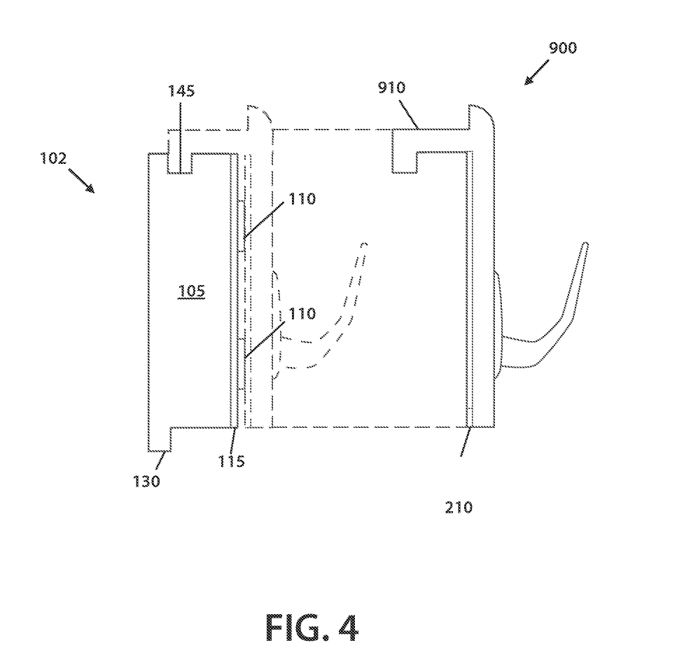

FIG. 3 shows that one embodiment of the upper portion of the fixture assembly 102 or hood receiver 120 may be a trench-hood receiver 145. The trench-hood receiver 145 preferably increases the overall carrying capacity performance of the customizable organizer assembly 50. The trench-hood receiver 145 preferably has one or more channels, trenches, troughs, or canals running along the length of the fixture assembly 102 (but it should be understood that they may face any direction without deviating from the scope of the invention), wherein the channel, trench, trough, or canal cooperatively interacts with an upper portion of the trench accessory mount assembly 900 or trench-hood 910 (i.e., another embodiment of the accessory mount assembly 200 and hood 220 shown in FIG. 4). Thus, the trench-hood receiver 145 preferably contacts, engages, and/or secures the trench-hood 910 of the trench accessory mount assembly 900, such that the channel, trench, or canal restricts the trench accessory mount assembly 900 from performing certain movements (including, but not limited to, up-down latitudinal mounting/dismounting rotations, right-left longitudinal mounting/dismounting rotations). As a result, the restrictions of these types of movements preferably result with the trench accessory mount assembly 900 to be more firmly secured to the fixture assembly 102, thereby increasing the carrying capacity of the accessory mount assembly 200. The weight load of the trench accessory mount assembly 900 is also preferably shifted from the first and second fasteners to the trench-hood 910 and trench-hood receiver 145 instead.

FIG. 4 is a side-view illustration of another embodiment of the fixture assembly and trench accessory mount assembly and shows the trench accessory mount assembly engaging with the fixture assembly. As shown in FIG. 4, the fixture assembly 102 may include: one or more first fasteners 110; a faceplate 115; fixture housing 105, a trench-hood receiver 145; and base receiver 130. FIG. 4 also shows the trench accessory mount assembly 900 to include a trench-hood 910 and second fastener 210. The trench-hood 910 of the trench accessory mount assembly 900 preferably engages with the trench-hood receiver 145 of the fixture assembly 102.

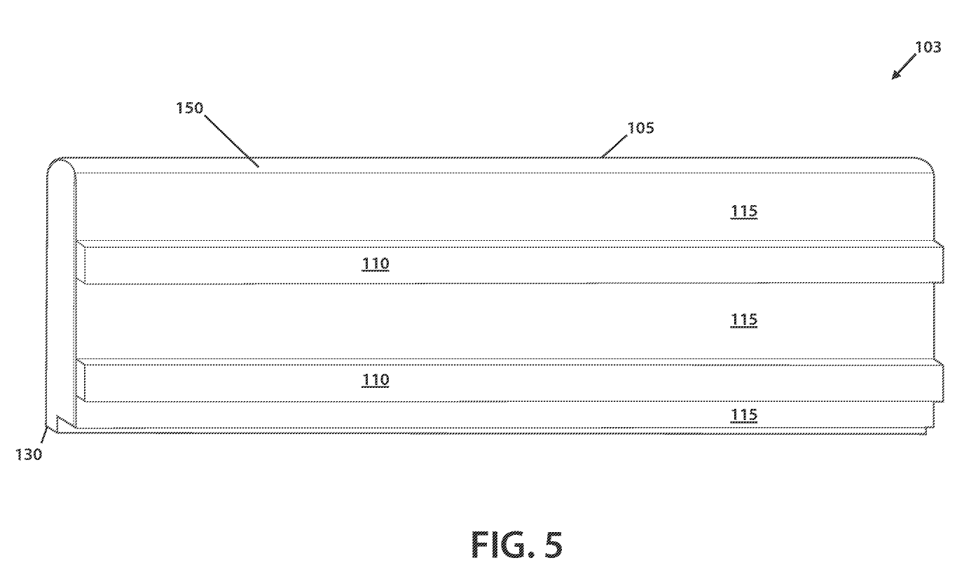

FIG. 5 is an illustration of another embodiment of the fixture assembly and shows the fixture assembly with a curved-hood receiver. As shown in FIG. 5, the fixture assembly 103 may include: one or more first fasteners 110; a faceplate 115; fixture housing 105; a curved-hood receiver 150; and base receiver 130.

Curved-Hood Receiver—

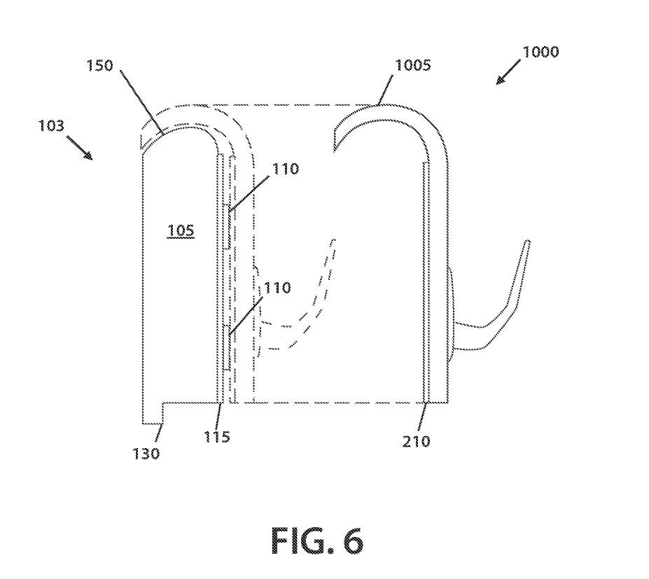

FIG. 5 shows that another embodiment of the upper portion of the fixture assembly 103 or hood receiver 120 may be a curved-hood receiver 150. The curved-hood receiver 150 is preferably a mound or semi-circular protrusion running along the length of the fixture assembly 103, wherein the mound cooperatively interacts with an upper portion of a curved-hood accessory mount assembly 1000 or curved-hood 1005, which is shown in FIG. 6, which is another embodiment of the accessory mount assembly 200 with hood 220, as shown in FIG. 1. Thus, the curved-hood receiver 150 preferably contacts, engages, and secures the curved-hood 1005 of the curved-hood accessory mount assembly 1000, such that mound or protrusion restricts the curved-hood accessory mount assembly 1000 from performing certain movements (including, but not limited to, up-down latitudinal mounting/dismounting rotations, right-left longitudinal mounting/dismounting rotations). As a result, the restrictions of these types of movements preferably result with the curved-hood accessory mount assembly 1000 to be more firmly secured to the fixture assembly 103, thereby increasing the carrying capacity of the curved-hood accessory mount assembly 1000. Preferably, the round shape of the curved-hood receiver 150 functions similar to a hill or mound, thereby forcing the curved-hood accessory mount assembly 1000 to initially rise over the mound/protrusion first, before detaching itself from the fixture assembly 103. The hood receiver may be constructed in various shapes such as flat, round, triangular without deviating from the scope of the invention.

FIG. 6 is a side-view illustration of another embodiment of the fixture assembly and curved-hood accessory mount assembly and shows the curved-hood accessory mount assembly engaging with the fixture assembly. As shown in FIG. 6, the fixture assembly 103 may include: one or more first fasteners 110; a faceplate 115; fixture housing 105; a curved-hood receiver 150; and base receiver 130. FIG. 6 also shows the curved-hood accessory mount assembly 1000 to include a curved-hood 1005 and second fastener 210. The curved-hood 1005 of the curved-hood accessory mount assembly 1000 preferably engages with the curved-hood receiver 150 of the fixture assembly 103.

Base Receiver—

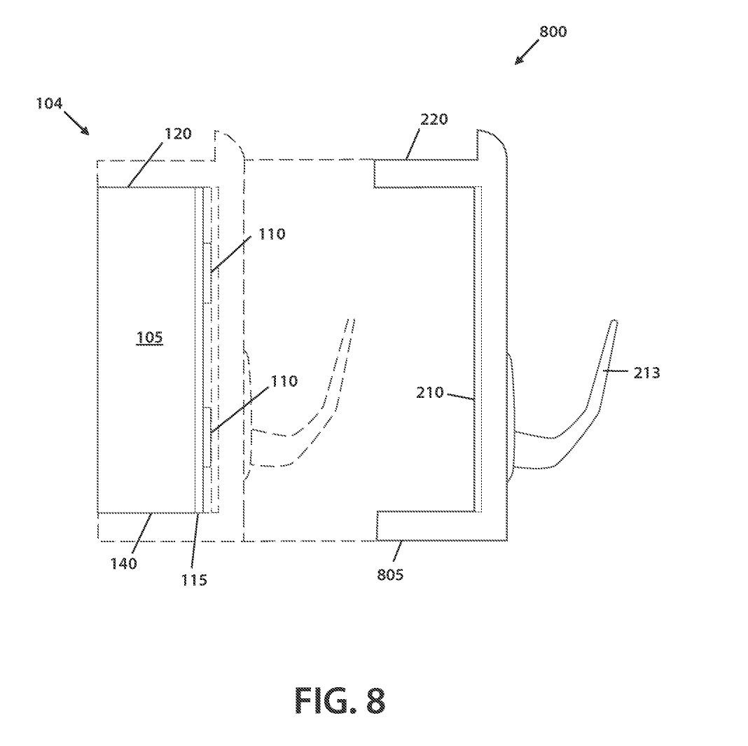

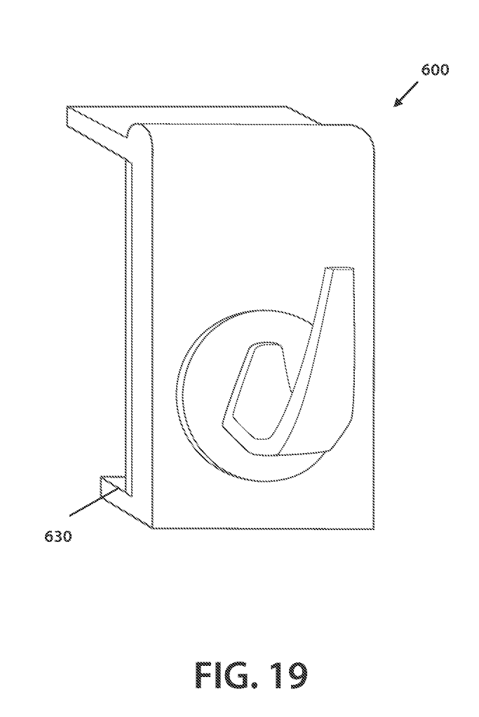

The lower portion of the fixture assembly 100, 102, 103, preferably referred to as the base receiver 130, preferably interacts with a base 265 or lower portion of a accessory mount assembly 200, which is shown in FIG. 1. The base receiver 130 may also interact with the snug-fit base 805 of a snug-fit accessory mount assembly 800, which is shown in FIG. 8, or base 630 of a bracket-shaped accessory mount assembly 600, which is shown in FIG. 19. The bracket-shaped accessory mount assembly 600 and snug-fit accessory mount assembly 800 are preferably additional embodiments of the accessory mount assembly 200 that increases the carrying capacity of the accessory mount assembly 200. Although the bracket-shaped accessory mount assembly 600 may be substantially “U-shaped”, it may be any shape, including, without limitation C-shaped, J-shaped, or U-shaped. The base receiver 130 may be configured in various shapes (including, but not limited to, round, rectangular, flat, etc.), and the shape and size of the base receiver 130 and base 265 should complement one another in order to optimize their interaction. Preferably, the interaction between the base receiver 130 and the base 265 requires the user to shift the rotational pivot point of the accessory mount assembly 200 during mounting/dismounting, such that the distance between the point of rotation and pivot point on the bracket-shaped accessory mount assembly 200 would increase, thereby creating more momentum. As such, the large momentum generally results with less force required for mounting/dismounting the accessory mount assembly 200. This is generally analogous to a door rotating about a hinge where it would be much easier to rotate that door from the position of the doorknob, but much harder to rotate that door from a few inches away from the hinge.

Another benefit of having a base receiver 130 is to prevent damage to a wall or surface that a fixture assembly 100, 102, 103 is secured on or attach to. If no base receiver 130 exists on the fixture assembly 100, an accessory mount assembly 200 with a base 265 may damage the wall or surface that the fixture assembly 100 is secured on. Thus, the base receiver 130 of the fixture assembly 100, 102, 103 generally protects the wall or surface that the fixture assembly 100, 102, 103 is attached to.

FIG. 7 is an illustration of another embodiment of the fixture assembly. As shown in FIG. 7, the fixture assembly 104 may include: one or more first fasteners 110; a faceplate 115; fixture housing 105; hood receiver 120; and snug-fit base receiver 140.

Snug-Fit Base Receiver—

The lower portion or surface of the fixture assembly 104 that runs along the bottom portion of the fixture assembly 104 also referred to as the “snug-fit base receiver” 140 preferably interacts with the snug-fit base 805 of the snug-fit accessory mount assembly 800 (as shown in FIG. 8) to eliminate any up-down, latitudinal rotational motion of the snug-fit accessory mount assembly 800. By eliminating these movements, the snug-fit accessory mount assembly 800 is more firmly attached to the fixture assembly 104, thereby increasing the load capacity of the snug-fit accessory mount assembly 800. The snug-fit base receiver 140 preferably minimizes the amount of fasteners needed in both the fixture assembly 104 and snug-fit accessory mount assembly 800.

FIG. 8 is a side-view illustration of another embodiment of the fixture assembly and snug-fit accessory mount assembly and shows the snug-fit accessory mount assembly engaging with the fixture assembly with a snug-fit base receiver. As shown in FIG. 8, the fixture assembly 104 may include: one or more first fasteners 110; a faceplate 115; fixture housing 105; hood receiver 120; and snug-fit base receiver 140. FIG. 8 also shows the snug-fit accessory mount assembly 800 to include a hood 220, second fastener 210, snug-fit base 805, and accessory 213. The snug-fit base 805 of the snug-fit accessory mount assembly 800 preferably engages with the snug-fit base receiver 140 of the fixture assembly 104.

### Bin Assembly for the Fixture Assembly

FIG. 9 is an illustration of another embodiment of the fixture assembly with a bin assembly. As shown in FIG. 9, the fixture assembly 106 may include: one or more first fasteners 110; faceplate 115; fixture housing 105; hood receiver 120; bin assembly 500; button fastener 501; and bin receiver 133.

Bin Receiver—

The bin receiver 133 is preferably any slot, indentation, channel, or space within the fixture housing 105 that secures the bin assembly 500 into or onto the fixture assembly 106. The bin assembly 500 is generally attached within or along the bin receiver 133 by any fastening mechanism and may be permanently or temporarily secured from the fixture assembly 106. The bin receiver 133 may be configured in various shapes and sizes (including, but not limited to, round, square, rectangular, triangular), and the shape and size of the bin receiver 133 preferably complements the shape and size of the bin assembly 500 in order to optimize their securing mechanisms. Each fixture assembly 100, 102, 103, 104, 106 may have one or more bin receivers, and each bin receiver 133 may be used as slots for the first fasteners 110 of the fixture assembly 106.

Regarding the various fastening mechanisms, both the bin receiver 133 and bin assembly 500 may attach or fasten to one another by the use of screws/bolts and button fasteners. Specifically, a screw/bolt and threaded hole may be used to secure the bin assembly 500 to the bin receiver 133. Alternatively, button fasteners may also be used to secure the bin assembly 500 to the bin receiver 133. Once the bin assembly 500 and fixture assembly 106 are secured together, via screw/bolt fasteners and/or button fasteners, another embodiment of the fixture assembly 106 is preferably formed. FIG. 9 shows the bin assembly with a button fastener 501.

FIG. 10 is an illustration of another embodiment of the fixture assembly with a bin receiver and shows the fixture assembly without the bin assembly. As shown in FIG. 10, the fixture assembly 106 may include: faceplate 115; fixture housing 105; hood receiver 120; button fastener 501; and bin receiver 133.

FIG. 11 is an illustration of another embodiment of the fixture assembly and bin assembly and shows the bin assembly engaging with the fixture assembly. As shown in FIG. 11, the customizable organizer assembly 50 may include: a fixture assembly 106 and bin assembly 500. The bin assembly 500 preferably engages with the bin receiver 133 of the fixture assembly 106.

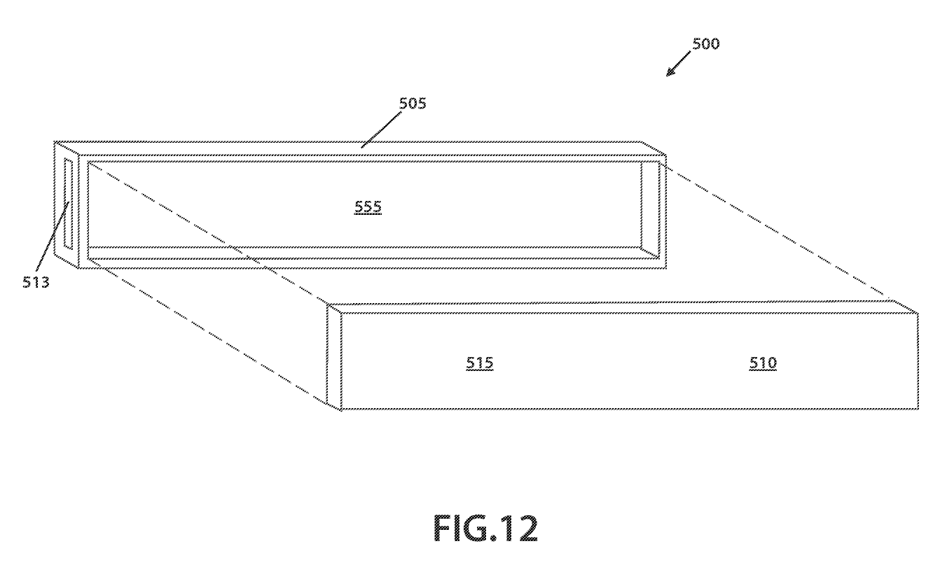

FIG. 12 is an illustration of another embodiment of the bin assembly and third fastener and shows the third fastener engaging with the bin assembly. As shown in FIG. 12, the bin assembly 500 may include: a housing 505; third fastener 510; button fastener 513; faceplate 515; and fastener slot 555. The bin assembly 500 is preferably a plurality of components that is secured onto a bin receiver 133 of the fixture assembly 106. The bin assembly 500 may be constructed in various shapes and sizes and generally provides the fixture assembly 106 with third fasteners 510 that cooperatively interact with the second fasteners 210 of the accessory mount assembly 200. Further, the accessory mount assembly 200 may removeably attach to the fixture assembly 100 via fasteners. Although FIG. 12 shows the bin assembly 500 with a third fastener 510, the bin assembly 500 may include one or more second fasteners, which interact with other components of the customizable organizer assembly.

When utilizing the bin assembly 500, the fixture assembly 100 may have many various fastener combinations. For example, a bin assembly 500 may have third fasteners 510 on a front surface and second fasteners on a rear surface. The second fasteners of the bin assembly 500 may engage with the first fasteners of the fixture assembly 106, and the third fasteners 510 of the bin assembly 500 may be exposed on the fixture assembly 106, functioning as the first contact surface 101 of the fixture assembly 106. Alternatively, the third fasteners 510 of the bin assembly 500 may engage with the first fasteners of the fixture assembly 106, such that the second fasteners of the bin assembly 500 are exposed as the first contact surface 101 of the fixture assembly 106. For example, assuming that one embodiment of the bin assembly 500 contains magnets as first fasteners, and a metal faceplate as second fasteners, a user may choose magnets or the metal faceplate as the exposed surface when the bin assembly 500 is attached to the fixture assembly 106. Thus, a single bin assembly 500 may provide the first contact surface 101 with multiple functions. A user may utilize a single bin assembly 500 with magnetic fasteners or convert the bin assembly 500 to non-magnetic fasteners.

Furthermore, a single bin assembly 500 containing two or more different fasteners on a single surface may provide the user with multiple options when customizing the customizable organizer assembly 50. Also, a bin assembly 500 with a surface having either an appealing surface design and fastening mechanism may provide the user with customizable aesthetic and functional features by simply re-attaching various faceplates of the bin assembly 500 to the fixture assembly 100.

Bin Housing—

The bin housing 505 is preferably the housing or main chassis of the bin assembly 500 and preferably houses the components associated with the bin assembly 500. As shown in FIG. 12, the bin housing 505 preferably encases third fasteners 510, which are preferably configured to mate or engage with the second fasteners 210 of the accessory mount assembly 200. The third fasteners 510 may be secured within the bin housing 505 or outside the bin housing 505.

Faceplate—

The faceplate 515 is preferably one or more metallic regions located on the bin assembly 500 that allows magnets to dock onto or attach to the fixture assembly 106. The faceplate 515 may also serve as an artistic canvas of the fixture assembly 100, such that the faceplate 515 may include customizable graphics, texts, engravings and other artistic renderings that reflect the artistic preference of the user. Alternatively, the faceplate 515 may also be used as a marketing tool by branding different business logos, trademark, and licensed characters.

Fastener Slot—

The fastener slot 555 is preferably any space or slot located in the bin housing 505, which allows the third fasteners 510 to be positioned within that space. Each bin assembly 500 may have one or more fastener slots 555.

### Cover Assembly

FIG. 13 is an illustration of another embodiment of the fixture assembly with a cover assembly. As shown in FIG. 13, the fixture assembly 107 may include: one or more first fasteners 110; faceplate 115; fixture housing 105; hood receiver 120; and base receiver 130. FIG. 13 also shows the cover assembly 400 to preferably comprise a cover 405, cover fastener 410, and faceplate 430.

Cover Receiver—

The fixture housing 105 may include a cover receiver, which is preferably one or more contact surfaces of the fixture housing 105 that contacts or interacts with a cover assembly 400. Specifically, the cover receiver of the fixture housing 105 preferably allows various cover assemblies to be secured onto the same fixture housing 105. The user may alternate and change one cover assembly 400 with another based upon characteristics, functionalities, aesthetics, and performance (i.e., weight carrying capacity).

Regarding the various securing mechanisms, the cover receiver and cover assembly 400 may utilize various fastening mechanisms, including without limitation: (1) screws/bolts and threaded holes, or (2) button fasteners. Once the cover assembly 400 is attached or fastened onto the cover receiver, the two objects (i.e., cover assembly 400 and fixture housing 105) are preferably secured together.

FIG. 14 is an illustration of one embodiment of a cover assembly. As shown in FIG. 14, the cover assembly 400 preferably includes: a cover 405, cover fastener 410; hood receiver 415; base receiver 420/snug-fit base receiver 425; and faceplate 430. The cover assembly 400 is preferably a housing that interacts with an accessory mount assembly 200, such that the accessory mount assembly 200 may attach and secured onto the fixture assembly 107. Specifically, the cover fastener 410 of the cover assembly 400 preferably mates or engages with the second fastener 210 of the accessory mount assembly 200 and the accessory mount assembly 200 preferably attaches or detaches from the fixture assembly 107. Each cover assembly 400 may have any type of fastener that may be used to attach the cover assembly 400 onto the fixture assembly 107.

Cover—

The cover 405 is preferably the main chassis or housing of the cover assembly 400, and preferably houses all of the components associated with the cover assembly 405.

Faceplate—

The faceplate 430 is preferably one or more metallic plates that is part of or secured onto the cover assembly 400, such that, when the cover assembly 400 is connected to the fixture assembly 100, 102, 103, 104, 106, 107 magnets may dock onto or attach to the fixture housing 105. Alternatively, like the faceplate 115 of the fixture housing 105, the faceplate 430 of the cover assembly 400 may also serve as an artistic canvas by including customizable graphics, texts, engravings, and other artistic renderings according to the preferences of a user. The faceplate 430 may also be used as a marketing tool by branding and commercializing different business logos, trademark, and licensed characters.

Hood Receiver—

Like the hood receiver 120 of the fixture assembly 100, the upper portion of the cover assembly 400 also referred to as the hood receiver 415 preferably mates or engages with the hood 220 of the accessory mount assembly 200. In particular, the hood receiver 415 of the cover assembly 400 preferably rests above, or matingly engages, with the hood receiver 120 of the fixture assembly 100, 102, 103, 104, 106, 107 and generally increases the carrying capacity of each accessory mount assembly 200 when the accessory mount assembly 200 is attached to the fixture assembly 100, 102, 103, 104, 106, 107. The hood receiver 415 of the cover assembly 400 may be configured in various shapes (e.g., round, flat, triangular) to optimize the interactions between the hood receiver 120 of the fixture assembly 100, 102, 103, 104, 106, 107 and the hood 220 of the accessory mount assembly 200.

Base Receiver—

When the cover assembly 400 is attached and secured onto the fixture assembly 100, 102, 103, 104, 106, 107, the lower portion of the cover assembly 400 also referred to as the base receiver 420 may engage with the base 265, 630 of an accessory mount assembly 200 (e.g., bracket-shaped accessory mount assembly 600). The base receiver 420 may have various shapes (e.g., round, rectangular, square, triangular) that preferably requires the user to shift the accessory mount assembly 200 at a particular pivot point when mounting or dismounting. For instance, if the distance between the point of rotation and pivot point on the accessory mount assembly 200 increases, less force is required and a larger momentum would result when mounting/dismounting the accessory mount assembly 200.

Snug-Fit Base Receiver—

When the cover assembly 400 is attached and secured onto the fixture assembly 100, 102, 103, 104, 106, 107, another embodiment of the cover assembly 400 may have a lower portion or surface as a “snug-fit base receiver”, which preferably contacts with the snug-fit base 805 or lower portion of a snug-fit accessory mount assembly 800. The contact between the snug-fit base receiver and snug-fit base 805 preferably eliminates any up-down, latitudinal motion of the snug-fit accessory mount assembly 800, thereby firmly securing the snug-fit accessory mount assembly 800 to the fixture assembly 104. As a result, the carrying capacity of the snug-fit accessory mount assembly 800 is improved, thereby minimizing the amount of fasteners needed in both the fixture assembly 104 and accessory mount assembly 200.

### Fixture Assembly Extensions

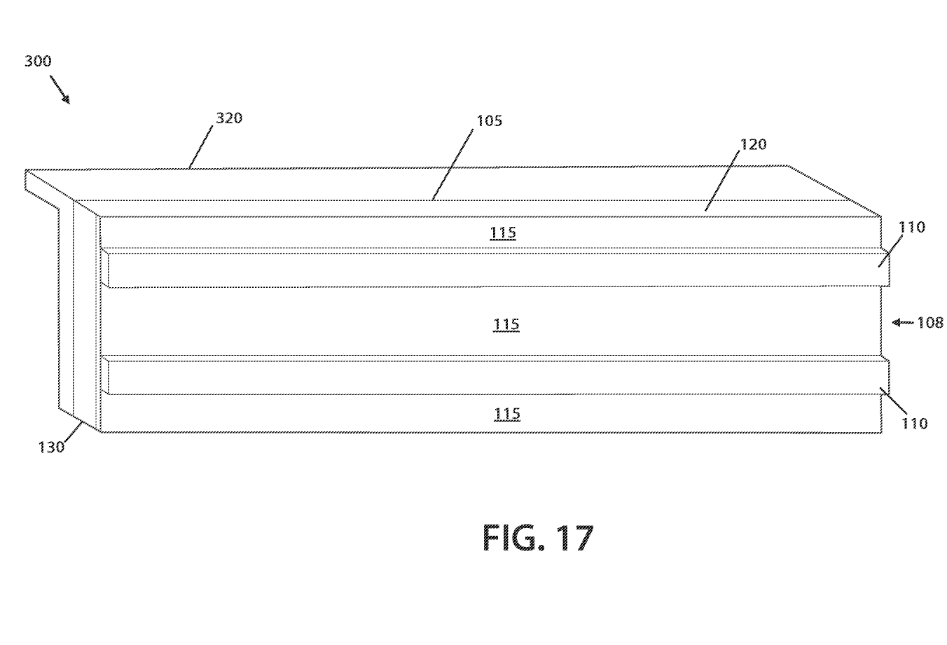

An extension 300 is preferably any device that is configured to secure the fixture assembly 100, 102, 103, 104, 106, 107, 108 to a particular surface and extend that fixture assembly 100, 102, 103, 104, 106, 107, 108 from that surface. Examples of such extensions include: hangers (shown in FIG. 15), bars (shown in FIG. 16), and L-brackets (shown in FIG. 17).

FIG. 15 is an illustration of another embodiment of the fixture assembly with hangers. As shown in FIG. 15, the fixture assembly 108 may include: one or more first fasteners 110; faceplate 115; fixture housing 105; hood receiver 120; base receiver 130; and hangers 310. The hanger 310 is preferably an extension 300 that allows the fixture assembly 108 to be secured onto a door or a barrier by hanging the fixture assembly 108 against that barrier. Specifically, the fixture housing 105 is directly attached to the hanger 310, and the hook portions of that hanger 310 is generally hung over a vertical barrier (including, but not limited to, a top portion of a door, wall, office cubicle, etc.), thereby securing the fixture assembly 108 onto that barrier. Preferably, the fixture assembly 108 can be removed from the barrier by simply lifting the hanger 310 off the barrier. The hanger 310 also allows the fixture assembly 108 to be secured onto the barrier without damaging the surface of the barrier (i.e., by creating fastening screw holes, nail holes, etc. . . . ). Furthermore, various fastening mechanisms such as screws/bolts and button fasteners may be used to attach the hanger 310 to the fixture assembly 108.

FIG. 16 is an illustration of another embodiment of the fixture assembly with bars. As shown in FIG. 16, the fixture assembly 108 may include: one or more first fasteners 110; faceplate 115; fixture housing 105; hood receiver 120; base receiver 130; bars 315; and extension mounting bracket 325. A bar 315 is preferably an extension 300 that allows the fixture assembly 108 to be secured onto any surface while suspending that fixture assembly 108 away from that surface. Specifically, a portion of the fixture housing 105 is preferably directly attached to a first end of the bar 315 while the second end of that bar 315 is preferably attached to and secured onto any designated surface, including uneven surfaces (including, but not limited to, a wall, machine, door, vehicle, etc.). Each bar 315 may be attached to the fixture assembly 108 by fasteners such as screws/bolts and button fasteners. Furthermore, although FIG. 16 shows each bar to be preferably straight, it should be understood that each bar may be any shape.

FIG. 17 is an illustration of another embodiment of the fixture assembly with an L-shaped bracket. As shown in FIG. 17, the fixture assembly 108 may include: one or more first fasteners 110; faceplate 115; fixture housing 105; hood receiver 120; base receiver 130; and L-shaped bracket 320. The L-shaped bracket 320 preferably allows the fixture assembly 108 to be secured onto any edge or ledge of another object or surface. Specifically, the fixture housing 105 is generally secured to a front side of the L-shaped bracket 320 via a fastener, and a second side (or two other sides) of the L-shaped bracket 320 is then secured onto an edge or ledge of another object or surface. Each L-shaped bracket 320 may be attached to the fixture assembly 108 by fasteners (including, but not limited to, magnets, screws/bolts and button fasteners) and the L-shaped bracket 320 may contain magnets on its rear side to magnetically attach the fixture assembly 108 to a metallic edge or ledge. The L-shaped bracket 320 may also be attached in other various ways such as adhesives, glues, Velcro®, and the like.

### Part II

### Component Description of the Accessory Mount Assembly

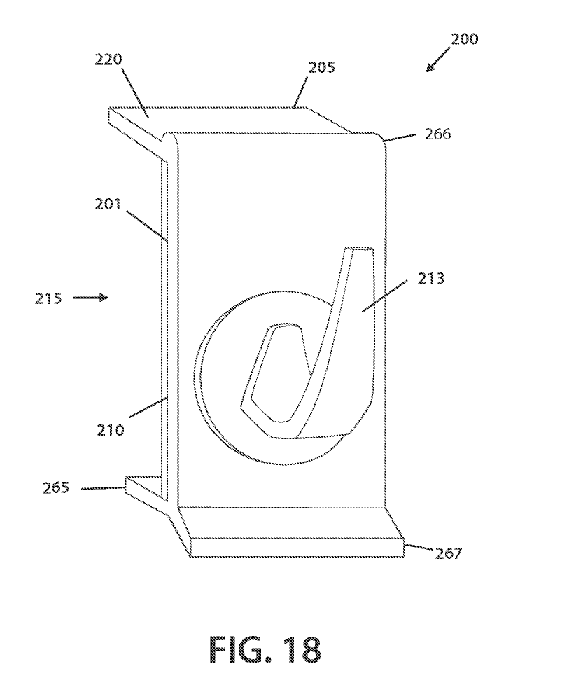

FIG. 18 is an illustration of one embodiment of an accessory mount assembly. As shown in FIG. 18, the accessory mount assembly 200 may include: accessory mount housing 205; second fasteners 210; rear side 215; hood 220; base 265; upper finger grip 266; lower finger grip 267; and accessory 213. As discussed above, the accessory mount assembly 200 may be directly secured onto a fixture assembly 100, 102, 103, 104, 106, 107, 108 or other object (e.g., utility carts, retail display equipment, point of sale, retail furniture, shelves, refrigerators, racks, storage shelves, metal beams of semi-trucks, metal frames, cargo bays, assembly lines, assembly line workspaces, conveyors, cubicle walls, cubicle workspaces, filing cabinets, metallic furniture, workbenches, tables, countertops, etc. . . . ). Each accessory mount assembly 200 may have second fasteners 210 that function as a second contact surface 201.

Second Contact Surface—

The second contact surface 201 is preferably one or more regions of the accessory mount assembly 200 comprising of a group of components or fasteners that interact with the fasteners belonging to the fixture assembly 100, 102, 103, 104, 106, 107, 108, bin assembly 500, or cover assembly 400. The second contact surface 201 is also preferably configured to allow the accessory mount assembly 200 to easily detach from the fixture assembly 100, 102, 103, 104, 106, 107, 108 or other object. In other words, the fixture assembly 100, 102, 103, 104, 106, 107, 108 and accessory mount assembly 200 may firmly attached to each other, but may be easily separated and reattached by the user. The second contact surface 201 is generally not a specific component or member of the accessory mount assembly 200, but rather, is preferably a representation of one or more components (e.g., second fasteners) of the accessory mount assembly 200. The second contact surface 201 of the accessory mount assembly 200 may also be configured in various sizes and shapes.

Generally, the second contact surface 201 of each accessory mount assembly 200 interacts with the first contact surface 101 of the fixture assembly 100, 102, 103, 104, 106, 107, 108 such that the accessory mount assembly 200 may easily and securely attached to the fixture assembly 100, 102, 103, 104, 106, 107, 108. The weight load of the accessory mount assembly 200 is also preferably shifted from the first and second fasteners to the hood 220 and hood receiver 120.

Each accessory mount assembly 200 may contain multiple accessories, and an accessory mount assembly 200 may be constructed in any size and shape. For example, the accessory mount assembly 200 may be large enough to have a plurality of accessories (e.g., an accessory 213 may be a hook or an entire rack of hooks). Furthermore, multiple accessory mount assemblies may mount onto or attach to a single fixture assembly 100, 102, 103, 104, 106, 107, 108, resulting with a variety of combinations and functionalities.

Each accessory mount assembly 200 may have an accessory 213 built-in, or removeably attached to the accessory mount assembly 200 through fasteners or connectors, including, but not limited to, screws, holes, bolts, button fasteners, magnets, adhesives, hook and loop fasteners, plastic snap lock strips, and fastening strips. This generally provides the user with the ability to choose his or her desired application (i.e., specific accessory), while, at the same time, be able to select their favorite tools, design, carrying capacity, and cost of each accessory mount assembly 200. The accessory mount assembly 200 may also utilize second fasteners 210 such that the accessory mount assembly 200 may firmly and securely attach to a fixture assembly 100, 102, 103, 104, 106, 107, 108 or other object (including, but not limited to, table, a countertop, a shelf, a railing, etc. . . . ). Also, the weight load of the accessory mount assembly 200 is also preferably shifted from the first and second fasteners to the hood 220 and hood receiver 120.

Regarding the use of fastening strips (e.g., plastic snap-lock strips similar to hook and loop fasteners or Velcro®), an accessory mount assembly 200 may be mounted to any object via fastening strips. For example, fastening strip generally has adhesive material on a first side and fastening members on a second side (including, but not limited to, hook and loop, snap buttons, locking studs, magnets, and the like). The adhesive side of one fastening strip is generally attached to a surface of an object (including, but not limited to, desk, a table, a shelf, a countertop, a utility cart) while the adhesive side of another fastening strip is then secured onto the rear side of an accessory mount assembly 200 or hood 220. This allows the accessory mount assembly 200 to fasten onto the designated object through the use of fastening strips. Thus, a user is preferably able to convert any object, surface, or piece of furniture into a dockable device for mounting his or her accessory mount assembly 200 quickly and effortless.

Accessory Mount Housing—

The accessory mount housing 205 is preferably the main chassis of the accessory mount assembly 200 and preferably houses the components associated with the accessory mount assembly 200.

Rear Side—

The rear or back portion of the accessory mount assembly 200 also referred to as the “rear side” 215 is preferably the surface that utilizes second fasteners 210 (including, but not limited to, magnets, metallic plates, adhesives, adhesive fasteners, hook and loop fasteners, Velcro®, etc. . . . ) to mate and engage with the first fasteners 110, which are preferably comprised of first contact surface 101, of the fixture assembly 100, 102, 103, 104, 106, 107, 108. This interaction generally allows the accessory mount assembly 200 to easily and securely mount onto the fixture assembly 100, 102, 103, 104, 106, 107, 108 and also effortlessly dismount or detach from the fixture assembly 100, 102, 103, 104, 106, 107, 108.

Hood—

The upper portion of the accessory mount assembly 200 or hood 220 preferably interacts or engages with the hood receiver 120 of the fixture assembly 100, 102, 103, 104, 106, 107, 108. Preferably, the hood 220 prevents the accessory mount assembly 200 from sliding off the fixture assembly 100 during use, and preferably increases the carrying capacity of the accessory mount assembly 200. An accessory mount assembly 200 may have one or more hoods, and each hood 220 may be configured in various shapes and sizes (including, but not limited to, round, flat, square, rectangular, triangular, etc.). For example, an accessory mount assembly may utilize various hoods such as a trench-hood 910 and curved-hood 1005. Preferably, in order to increase the load capacity, the shape of the hood 220 of the accessory mount assembly 200 should complement the shape of the hood receiver 120 of the fixture assembly 100, 102, 103, 104, 106, 107, 108. The hood 220 may also include one or more holes or protrusions that function as an upper finger-grip for the accessory mount assembly 200, such that a user may slide his or her fingers into the holes or protrusions of the hood 220 to assist him or her in dismounting or detaching that accessory mount assembly 200. Also, the weight load of the accessory mount assembly 200 is also preferably shifted from the first and second fasteners to the hood 220 and hood receiver 120.

Base—

The accessory mount assembly 200 may include a lower portion also referred to as the base 265. The base 265 is generally included in only a bracket-shaped accessory mount assembly 600 (e.g., snug-fit accessory mount assembly 800). The base 265 preferably interacts or contacts with the base receiver 130 of the fixture assembly 100, 102, 103, 104, 106, 107, 108 and preferably allows a user to easily dismount or detach the accessory mount assembly 200 from the fixture assembly 100, 102, 103, 104, 106, 107, 108. The interaction between the base 265 and base receiver 130 generally shifts the pivot point of the accessory mount assembly 200 when dismounting from a fixture assembly 100, 102, 103, 104, 106, 107, 108. The base 265 may be configured in various shapes and sizes and preferably complements the shape and size of the base receiver 130 of the fixture assembly 100, 102, 103, 104, 106, 107, 108.

Accessory—

As discussed above, the accessory 213 is generally any object or device used for a specific function or task. The accessory 213 may be part of the accessory mount assembly 200 as a single object—i.e., the accessory 213 is not detachable from the accessory mount assembly 200—, or the accessory 213 may be removeably attachable to accessory mount assembly 200 via fasteners (including, but not limited to, screw/bolts, button fasteners, adhesives, magnets, and hook and loop fasteners) and other attachment methods. The accessory mount assembly 200 may also include other components such as an upper finger grip and lower finger grip.

Upper Finger Grip—

The upper finger grip 266 is preferably a portion of the accessory mount assembly 200 generally located near the hood that assists the user to mount or dismount the accessory mount assembly 200 with his or her fingers. The upper finger grip 266 may consist of one or more protrusions or one or more holes of various shapes and sizes, and each accessory mount assembly 200 may have one or more upper finger grips.

Lower Finger Grip—

The lower finger grip 267 is preferably a portion of the accessory mount assembly 200 that is generally located near the base 265 of the accessory mount assembly 200 and preferably assists the user to mount or dismount the accessory mount assembly 200 with his or her fingers. The lower finger grip 267 may consist of one or more protrusions or one or more holes of various shapes and sizes, and each accessory mount assembly 200 may have one or more lower finger grips.

### Alternative Embodiments of the Accessory Mount Assembly

The accessory mount assembly 200 may either be a bracket-shaped accessory mount assembly 600 or an L-shaped accessory mount assembly 700.

FIG. 19 is an illustration of one embodiment of a bracket-shaped accessory mount assembly. The bracket-shaped accessory mount assembly 600 is preferably an accessory mount assembly 200 with a substantially “bracket-shaped” or “U-shaped” body or housing. The bracket-shaped accessory mount assembly 600, unlike other accessory mount assemblies, typically has a base 630. When attached to a fixture assembly 100, 102, 103, 104, 106, 107, 108 and interacting with a base receiver 130, the bracket-shaped accessory mount assembly 600 may shift its pivot point (i.e., the lateral area for mounting and dismounting) and transfer its pivot point to the base receiver 130 of the fixture assembly 100, 102, 103, 104, 106, 107, 108. This generally allows the bracket-shaped accessory mount assembly 600 to easily dismount or detach from the fixture assembly 100, 102, 103, 104, 106, 107, 108 while maintaining its high load capacity characteristic.

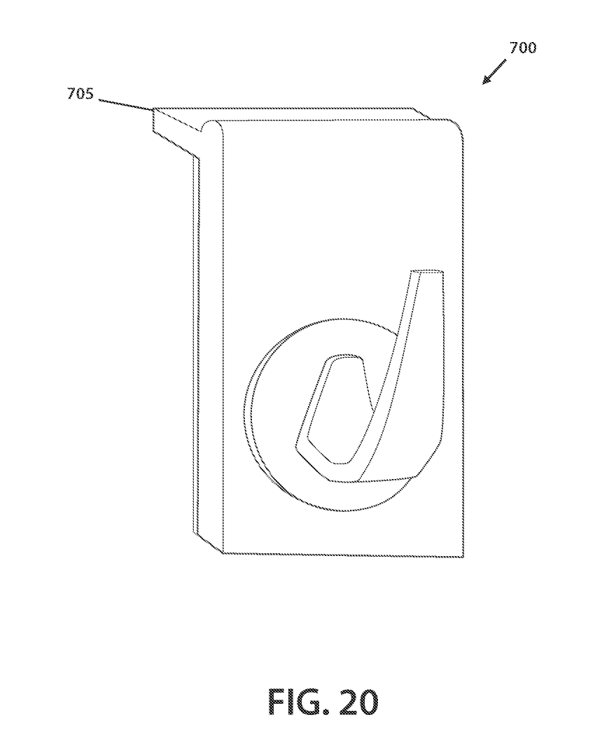

FIG. 20 is an illustration of one embodiment of an L-shaped accessory mount assembly. The L-shaped accessory mount assembly 700 is preferably an accessory mount assembly 200 with substantially “L-shaped” body or housing. The L-shaped accessory mount assembly 700, unlike other accessory mount assemblies, generally lacks a base 630 and a snug-fit base 805. The lacking of a base 630 and snug-fit base 805 generally provides versatility to the L-shaped accessory mount assembly 700, such that the L-shaped accessory mount assembly 700 may interact with virtually any similar edge or ledge, and, in this case a flat horizontal ledge surface. Specifically, the L-shaped accessory mount assembly 700 may contact an edge or ledge through two contact surfaces via fasteners—(1) the vertical rear side of the L-shaped accessory mount assembly 700 and (2) the horizontal underside of the L-shaped accessory mount assembly 700 via hood 705. If a second fastener 210 is located underneath the hood 705, the L-shaped accessory mount assembly 700 can securely attach itself onto the top surface of the edge/ledge.

The L-shaped accessory mount assembly 700 may attach to the fixture assembly 100, 102, 103, 104, 106, 107, 108 or any object, including without limitation, tables, countertops, microwaves, machines, bars, beams, vehicles, railings, fences, utility carts, magnetic knife holders, magnetic tool holders, retail display equipment for retail stores, point of sale retail furniture (e.g., shelves, refrigerators, standing signs, racks), storage shelves, metallic beams in semi-trucks, assembly lines in factories and manufacturing plants, small office walls of cubicle workspaces, filing cabinets, storage shelves in mechanic and tooling shops, and other objects with a substantially horizontal surface. For example, if an edge/ledge of an object is metallic, then an L-shaped accessory mount assembly 700 utilizing magnetic fasteners may easily and securely mount/attach itself onto that edge/ledge. Alternatively, if an edge/ledge of an object is utilizing material other than metals (including, but not limited to, wood, plastic, or composites), then an L-shaped accessory mount assembly 700 utilizing adhesive fasteners may easily and securely mount onto or attach to that edge/ledge. Once attached, the L-shaped accessory mount assembly 700 will preferably function just as well as if it were mounted onto a fixture assembly 100, 102, 103, 104, 106, 107, 108. The L-shaped accessory mount assembly 700 may also be used for marketing such as retail display equipment for point-of-sale or may be used for other functions as well (including, but not limited to, organizing items via racks, hooks, containers, shelves, trays, sign holders, price display, and the like).

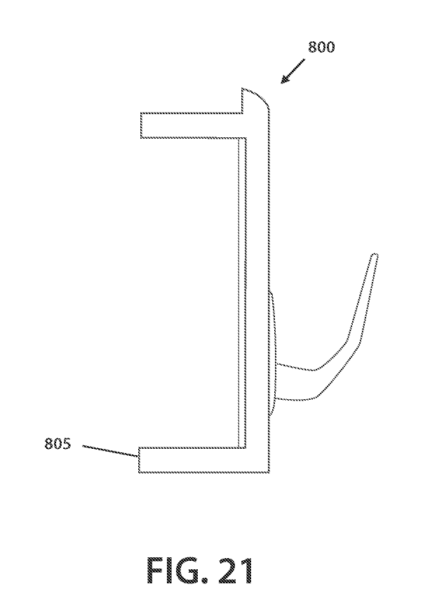

FIG. 21 is an illustration of one embodiment of a snug-fit accessory mount assembly. The snug-fit accessory mount assembly 800 that preferably has a bracket-shaped body with a lower portion or snug-fit base 805 that interacts directly with the a snug-fit base receiver 140 of a fixture assembly 104. The snug-fit base 805 generally interacts with the snug-fit base receiver 140 of the fixture assembly 104, and this interaction between the snug-fit base 805 and snug-fit base receiver 140 preferably allows the snug-fit accessory mount assembly 800 to hug the fixture assembly 104 tightly, thereby securing the snug-fit accessory mount assembly 800 onto the fixture assembly 104. The interaction between the snug-fit base 805 and the snug-fit base receiver 140 preferably restricts the snug-fit accessory mount assembly 800 from performing any latitudinal (i.e., up-down) mounting/dismounting movements. Because the snug-fit accessory mount assembly 800 precisely mates or engages with a fixture assembly 104, the inherent shape and configuration of the snug-fit accessory mount assembly 800 secures itself tightly onto the fixture assembly 104. This mating mechanism preferably improves the load capacity of the snug-fit accessory mount assembly 800.

The snug-fit base 805 may be configured in various sizes and shapes, and a single snug-fit accessory mount assembly 800 may utilize multiple snug-fit bases. The snug-fit base 805 and snug-fit base receiver 140 preferably complement each other in size and shape to optimize the fastening mechanism between the snug-fit accessory mount assembly 800 and fixture assembly 104.

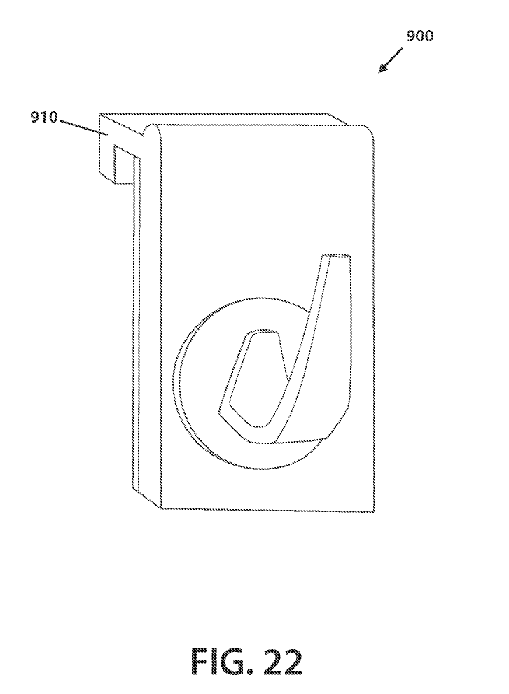

FIG. 22 is an illustration of one embodiment of a trench accessory mount assembly. The trench accessory mount assembly 900 preferably utilizes a trench-hood 910, which interacts with the trench-hood receiver 145 of a fixture assembly 102 in order to increase the carrying capacity performance of the trench accessory mount assembly 900. Specifically, the trench-hood 910 generally resembles a hood 220, with an additional protrusion extending vertically downward. This protrusion generally allows the hood 220 to hook onto, matingly engage with, or be secured within a trench/channel, of the trench-hood receiver 145. This hooking action preferably shifts the weight or load from the second fasteners 210 to the trench-hood 910.

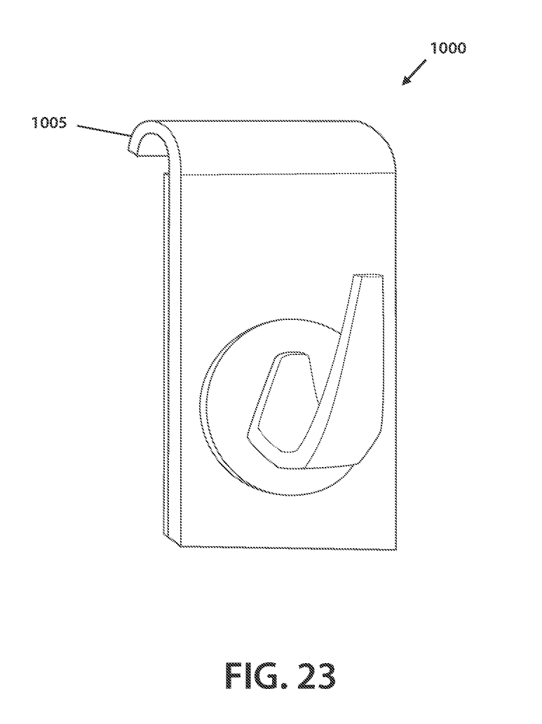

FIG. 23 is an illustration of one embodiment of a curved-hood accessory mount assembly. The curved-hood accessory mount assembly 1000 preferably utilizes a hood with a substantially semi-circular shape (i.e., curved-hood 1005), which preferably interacts with a curved-hood receiver 150 likewise having a substantially semi-circular shape. The substantially semi-circular shape of the curved-hood 1005 and curved-hood receiver 150 preferably complement each other, such that the carrying capacity of the curved-hood accessory mount assembly 1000 is greater than an accessory mount assembly 200 utilizing a hood 220 with a flat surface. The round, elliptical, or curved shape of the curved-hood 1005 preferably hooks onto the curved-hood receiver 150 of the fixture assembly 103, thereby shifting a portion of the weight or load away from the second fasteners 210 to the curved-hood 1005 instead. Although the curved-hood accessory mount assembly 1000 generally has a round surface, the hood of the curved-hood 1005 may also have other shapes as well (e.g., triangular).

### Bin Assembly for the Accessory Mount Assembly

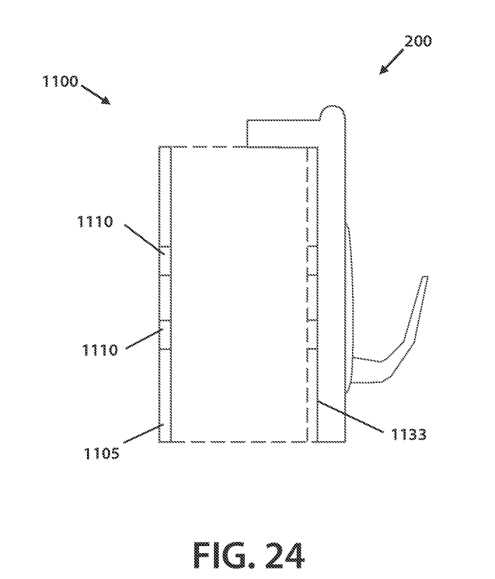

FIG. 24 is an illustration of one embodiment of an accessory mount assembly with a bin assembly and shows how the bin assembly engages with the accessory mount assembly. Rather than having fasteners located on the rear side or rear portion of the accessory mount assembly 200, the rear portion of the accessory mount assembly 200 may also serve as a bin assembly receiver 1133 for the bin assembly 1100 of the accessory mount assembly 200. Preferably, the bin assembly 1100 functions as the second contact surface 201 (shown in FIG. 1) of the accessory mount assembly 200, such that the interactions between the first contact surface 101 of the fixture assembly 100, 102, 103, 104, 106, 107, 108 and the second contact surface 201 of the bin assembly 1100 preferably allow the accessory mount assembly 200 to attach to and detach from the fixture assembly 100, 102, 103, 104, 106, 107, 108.

The bin assembly 1100 may be secured into the bin assembly receiver 1133 via fasteners (e.g., button fasteners, as shown in FIG. 24), and the bin assembly 1100 is generally composed of a bin housing 1105, fastener(s) (including, but not limited to, screws/bolts, threaded fasteners, button fasteners, magnets/metallic plates, etc.), and other components.

Bin Housing—

The bin housing 1105 is preferably the chassis or housing of the bin assembly 1100 and preferably encases or houses the third fasteners 1110 (i.e., the second contact surface 201), which are configured to interact with the first fasteners 110 (i.e., the first contact surface 101) of the fixture assembly 100, 102, 103, 104, 106, 107, 108. The third fasteners 1110 may be secured within the bin housing 1105 or secured onto the outside of the bin housing 1105.

Third Fasteners—

As discussed above, the third fasteners 1110 of the bin assembly 1100 preferably interact with the first fasteners 110 (i.e., first contact surface 101) of the fixture assembly 100, 102, 103, 104, 106, 107, 108. The third fasteners 1110 of the bin assembly 1100 may be constructed with magnets, metal plates, hook and loop fasteners, Velcro®, adhesives, and the like and may be constructed in various sizes and shapes. Each bin assembly 1100 may have one or more third fasteners 1110.

### Detachable Accessory Assembly

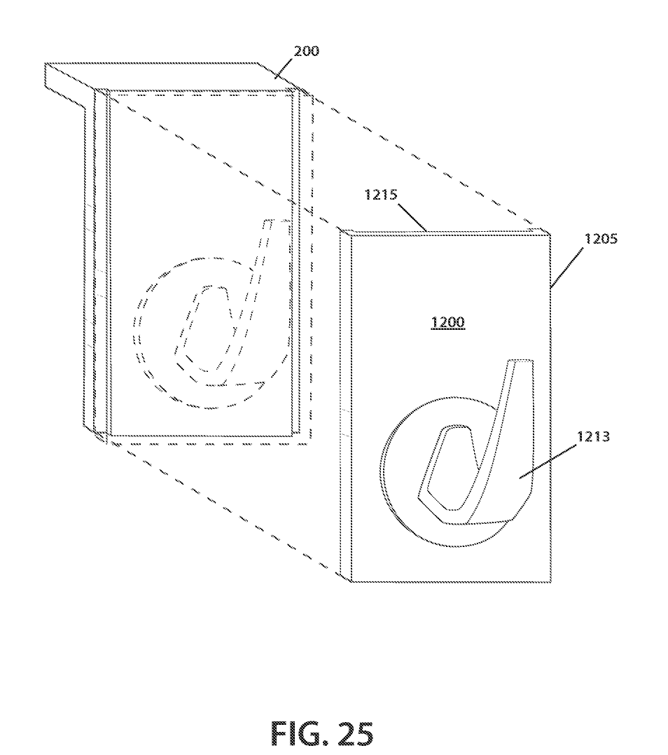

FIG. 25 is an illustration of one embodiment of an accessory mount assembly with a detachable accessory assembly. The detachable accessory assembly 1200 preferably utilizes an accessory 1213 that is detachable from the accessory mount assembly 200. When attached, the detachable accessory assembly 1200 becomes the current active accessory of the accessory mount assembly 200. The detachable accessory assembly 1200 is preferably disposable, swappable, or interchangeable, thereby providing the user with the ability to interchange various accessories. For example, a user seeking an accessory 1213 with a large carrying capacity may replace a particular detachable accessory assembly with a different detachable accessory assembly having a larger load capacity. Alternatively, a user can simply replace a detachable accessory assembly 1200 if it malfunctions or breaks. Preferably, any fasteners and other securing methods may be used to attach the detachable accessory assembly 1200 to the accessory mount assembly 200.

The detachable accessory assembly 1200 may include: a detachable housing 1205, rear side 1215; and accessory 1213. The detachable housing 1205 is preferably the main chassis of the detachable accessory assembly 1200 and generally houses or encases the components associated with the detachable accessory assembly 1200. The rear side 1215 is preferably the backside or rear portion of the detachable accessory assembly 1200. The accessory 1213 of the detachable accessory assembly 1200 is preferably any device that performs a specialized or organizational task of the accessory mount assembly 200. The detachable accessory assembly 1200 may generally utilizes any type of fastener or connector, including, but not limited to, screws/bolts, button fasteners, magnets/metallic plates, and the like, to fasten or attach itself to the accessory mount assembly 200.

### Part III

### Additional Embodiments

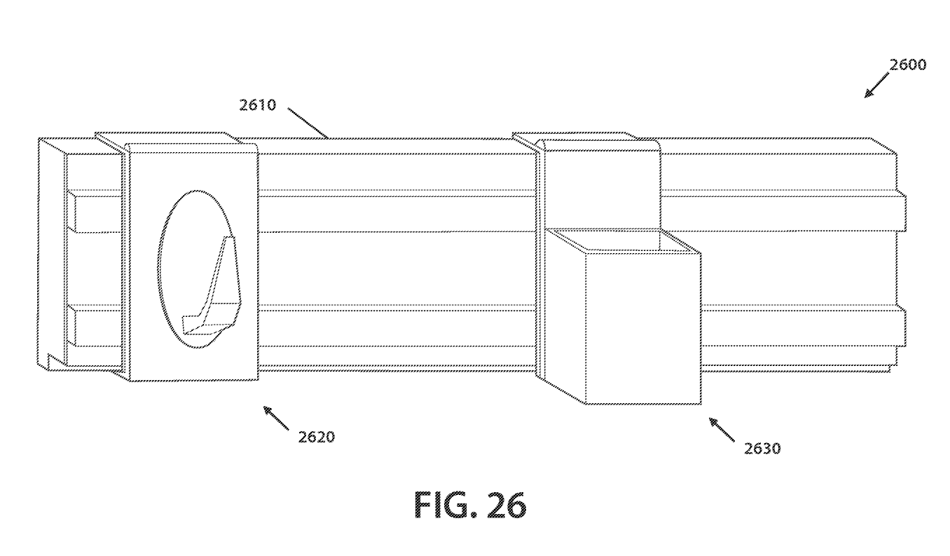

FIG. 26 is an illustration of another embodiment of the customizable organizer assembly and shows the fixture assembly with two accessory mount assemblies. As shown in FIG. 26, the customizable organizer assembly 50 may include a fixture assembly 2610, first accessory mount assembly 2620, and second accessory mount assembly 2630. FIG. 26 shows the first accessory mount assembly 2620 to be a bracket-shaped accessory mount assembly 700 with a hook as an accessory 213. FIG. 26 also shows the second accessory mount assembly 2630 to be an L-shaped accessory mount assembly 600 with a container as an accessory 213.

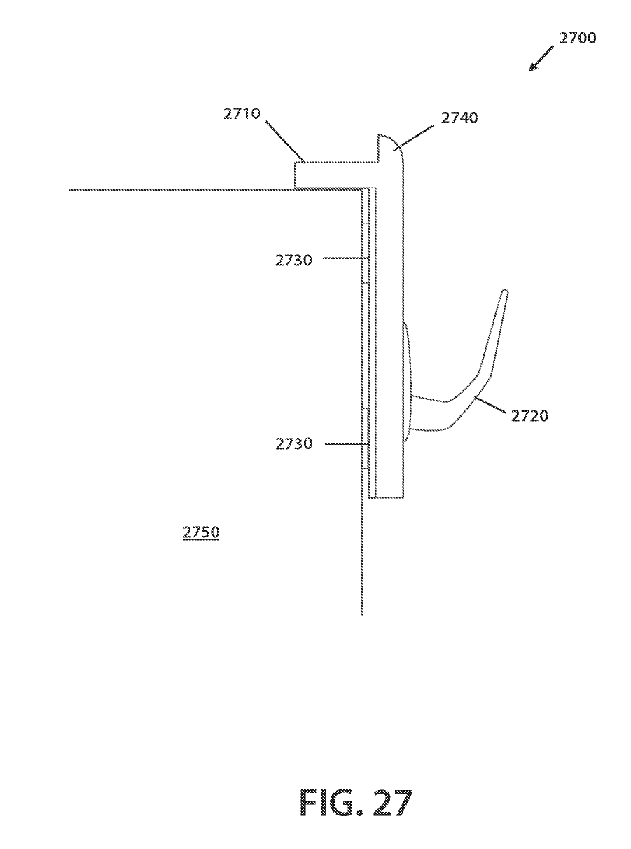

FIG. 27 is an illustration of another embodiment of the L-shaped accessory mount assembly and shows the L-shaped accessory mount assembly attached to a metallic edge. As shown in FIG. 27, the L-shaped accessory mount assembly 2700 may include a hood 2710, accessory 2720, second fasteners 2730, and upper finger grip 2740. FIG. 27 shows that the second fasteners 2730 may be located on the rear side of the L-shaped accessory mount assembly 2700 and may be magnetic fasteners, which preferably, removeably attach onto an edge 2750. FIG. 27 also shows that the accessory 2720 may be a hook.

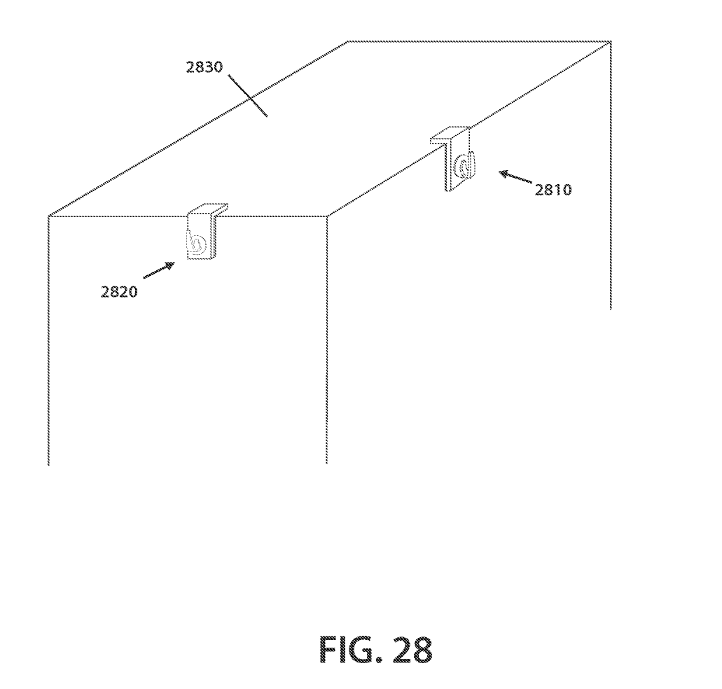

FIG. 28 is an illustration of another embodiment of two L-shaped accessory mount assemblies magnetically attached to a metallic edge of an object. FIG. 28 shows that the accessory mount assemblies 2810, 2820 are L-shaped accessory mount assemblies, with magnetic fasteners, which may be attached to a metallic surface edge or ledge of an object 2830. Preferably, the fasteners of accessory mount assemblies 2810, 2820 are magnetic fasteners.

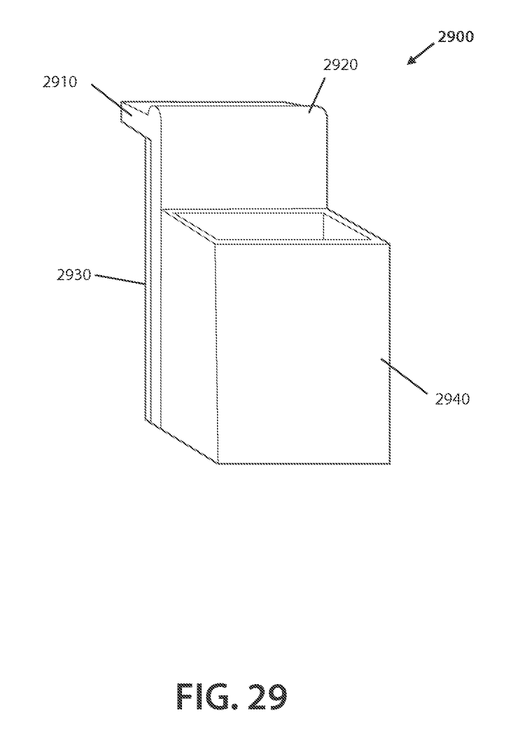

FIG. 29 is an illustration of another embodiment of the L-shaped accessory mount assembly and shows the accessory mount assembly with the accessory as a rectangular shaped container. As shown in FIG. 29, the L-shaped accessory mount assembly 2900 may include a hood 2910, upper finger grip 2920, second fastener 2930, and accessory 2940. FIG. 29 shows that the second fastener 2930 may be a metallic plate on the rear side of the L-shaped accessory mount assembly 3000 and that the accessory 2940 is a rectangular shaped container or holder.

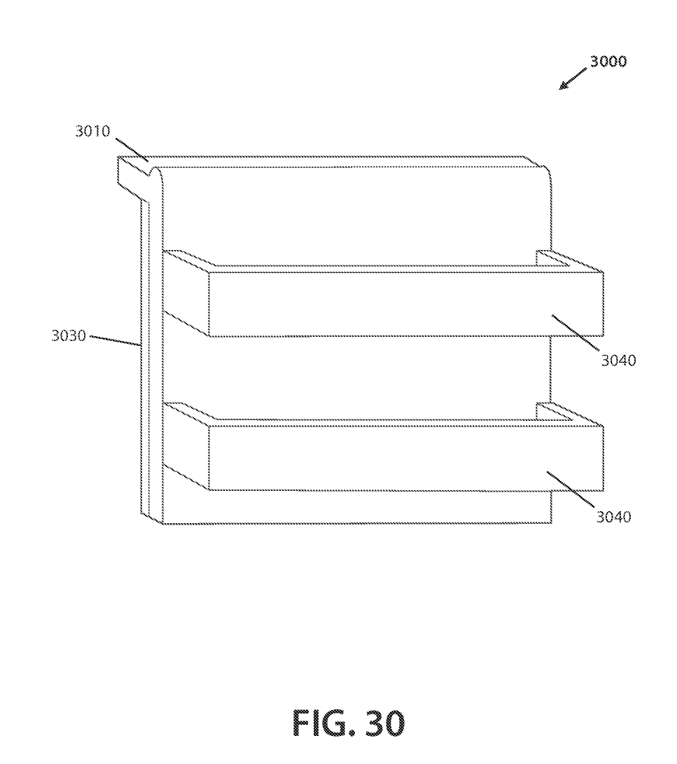

FIG. 30 is an illustration of another embodiment of the L-shaped accessory mount assembly and shows the accessory mount assembly with the accessory as two hanger bars. As shown in FIG. 30, the L-shaped accessory mount assembly 3000 may include a hood 3010, upper finger grip 3020, second fastener 3030, and accessory 3040. FIG. 30 shows that the second fastener 3030 may be a metallic plate on the rear side of the L-shaped accessory mount assembly 3000 and that the accessory 3040 may be two hanger bars for hanging objects thereon.

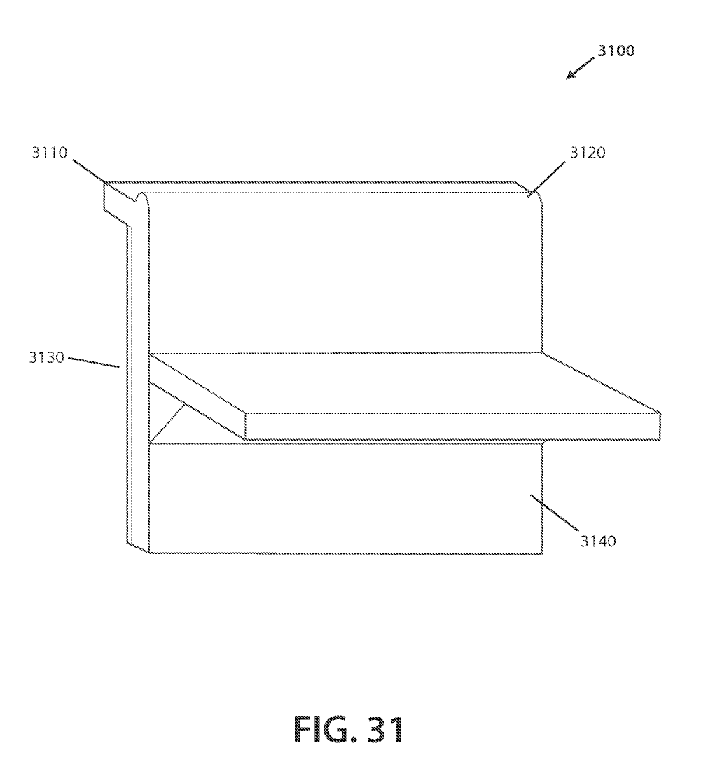

FIG. 31 is an illustration of another embodiment of the L-shaped accessory mount assembly and shows the accessory mount assembly with the accessory as a shelf. As shown in FIG. 31, the L-shaped accessory mount assembly 3100 may include a hood 3110, upper finger grip 3120, second fastener 3130, and accessory 3140. FIG. 31 shows that the second fastener 3130 may be a metallic plate on the rear side of the L-shaped accessory mount assembly 3100 and that the accessory 3140 may be a shelf for placing items.

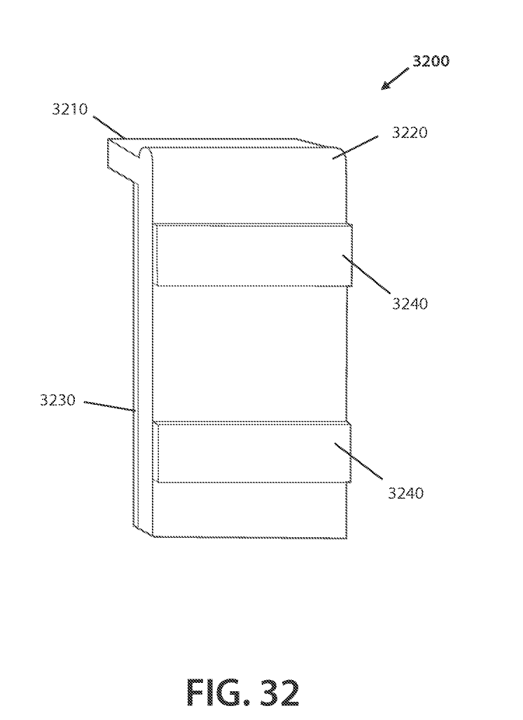

FIG. 32 is an illustration of another embodiment of the L-shaped accessory mount assembly and shows the accessory mount assembly with magnets. As shown in FIG. 32, the L-shaped accessory mount assembly 3200 may include a hood 3210, upper finger grip 3220, second fastener 3230, and additional fasteners 3240. FIG. 32 shows that the second fastener 3230 may be a metallic plate on the rear side of the L-shaped accessory mount assembly 3200. The additional fasteners 3240 may be used to enable metallic objects to magnetically attach to the L-shaped accessory mount assembly 3200.

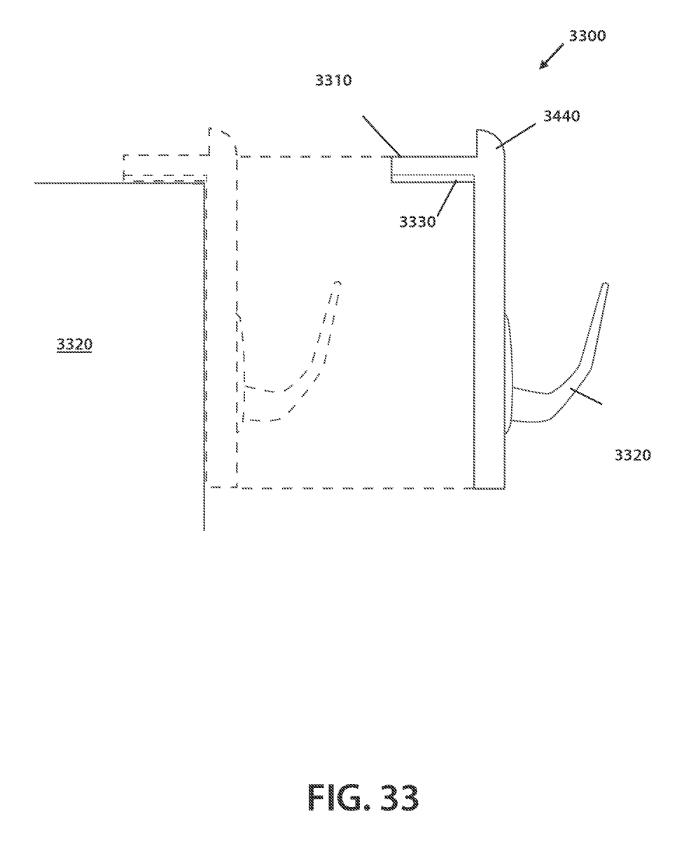

FIG. 33 is an illustration of another embodiment of the L-shaped accessory mount assembly with an adhesive fastener beneath the hood and shows how the accessory mount assembly attaches to an edge with the adhesive fastener underneath the hood. As shown in FIG. 33, the L-shaped accessory mount assembly 3300 may include a hood 3310, accessory 3320, second fastener 3330, and upper finger grip 3340. FIG. 33 shows that the second fastener 3330 may be located on beneath the hood 3310 of the L-shaped accessory mount assembly 3300 and may be an adhesive fastener, which preferably, removeably attaches onto an edge 3320. FIG. 33 also shows that the accessory 3320 may be a hook.

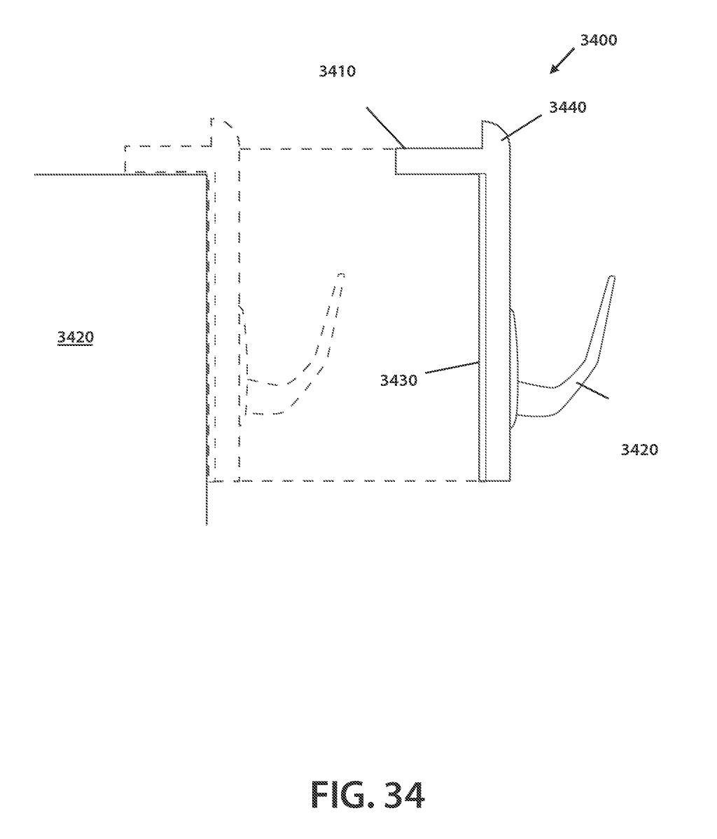

FIG. 34 is an illustration of another embodiment of the L-shaped accessory mount assembly with an adhesive fastener on its rear side and shows how the accessory mount assembly attaches to an edge with the adhesive fastener through the rear side. As shown in FIG. 34, the L-shaped accessory mount assembly 3400 may include a hood 3410, accessory 3420, second fastener 3430, and upper finger grip 3440. FIG. 34 shows that the second fastener 3430 may be located on the rear side of the L-shaped accessory mount assembly 3400 and may be an adhesive fastener, which preferably, removeably attaches onto an edge 3420. FIG. 34 also shows that the accessory 3420 may be a hook.

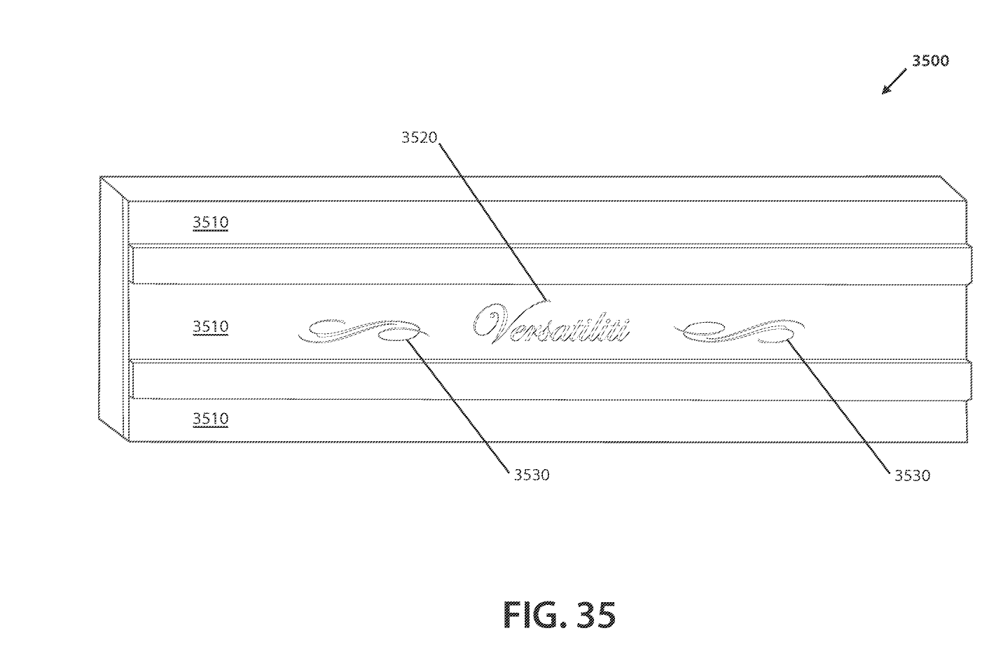

FIG. 35 is an illustration of one embodiment of the fixture assembly and shows the faceplate of the fixture assembly with texts and graphics. As shown in FIG. 35, the fixture assembly 3500 may include a faceplate 3510, wherein the faceplate 3510 may include texts 3520 and graphics 3530. Although FIG. 35 shows the term “VERSATILI” on the faceplate, it should be understood that any text may be used on the faceplate. Additionally, any graphics may be used without deviating from the scope of the invention.

### Part V

### Fields of Application

The following are examples are various applications of the invention in order to help provide a thorough understanding of various aspects of one or more embodiments of the invention. While multiple applications and embodiments are disclosed, the invention is capable of modifications in various obvious aspects, all without departing from the spirit and scope of the present invention. Accordingly, the following examples are to be regarded as illustrative in nature and not restrictive.

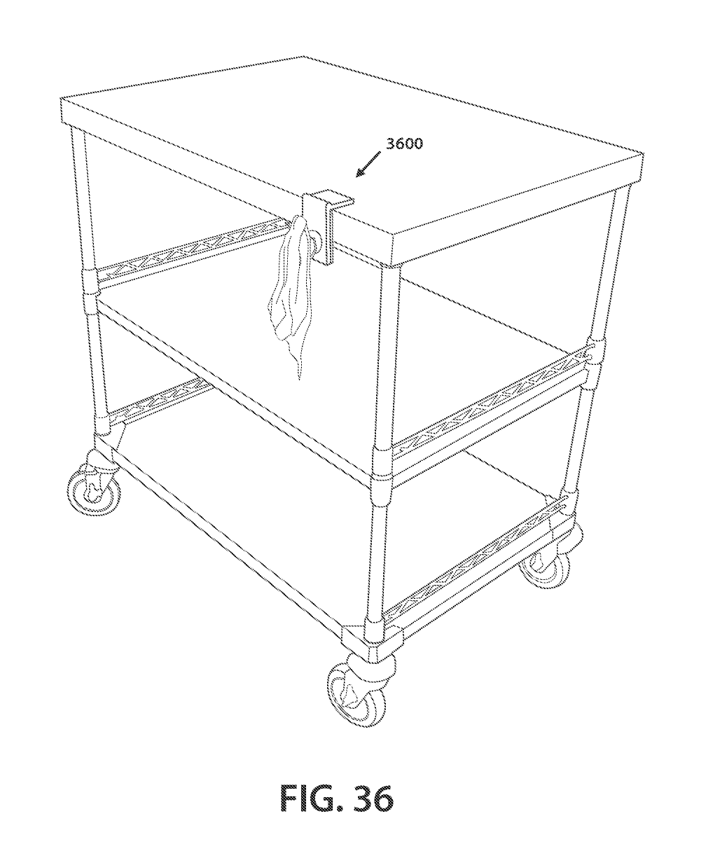

FIG. 36 is an illustration of one embodiment of the accessory mount assembly and shows the accessory mount assembly attached to a utility cart. Specifically, the accessory mount assembly 3600 may include magnetic fasteners that removeably attach to a metallic surface of the utility cart. FIG. 36 also shows that the accessory mount assembly 3600 may have a hook as an accessory for holding a piece of cloth.

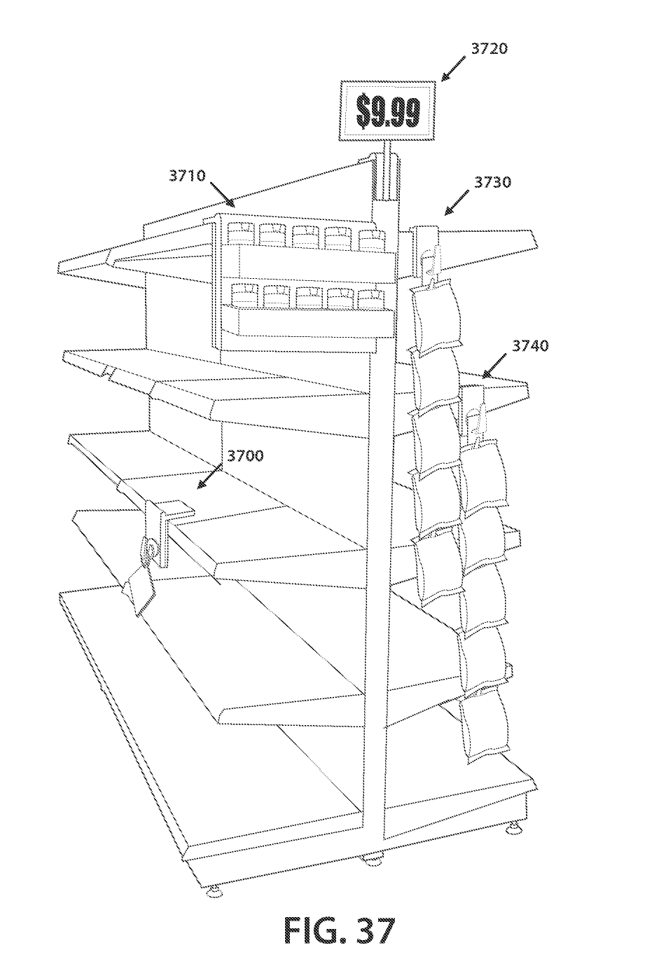

FIG. 37 is an illustration of additional embodiments of the accessory mount assembly and shows the accessory mount assemblies attached to a retail display equipment of a retail store. As shown in FIG. 37, the accessory mount assemblies may include: a first accessory mount assembly 3700; second accessory mount assembly 3710; third accessory mount assembly 3720; fourth accessory mount assembly 3730; and fifth accessory mount assembly 3740 and preferably may include magnetic fasteners or adhesive fasteners that removeably attach to the retail display equipment. The first accessory mount assembly 3700 may have a hook as an accessory for holding a key; the second accessory mount assembly 3710 may have a rack as an accessory for holding spices; third accessory mount assembly 3720 may have a sign holder as an accessory for holding a price display sign; and the fourth accessory mount assembly 3730 and fifth accessory mount assembly 3740 each may have a snack holder for holding bags of chips.

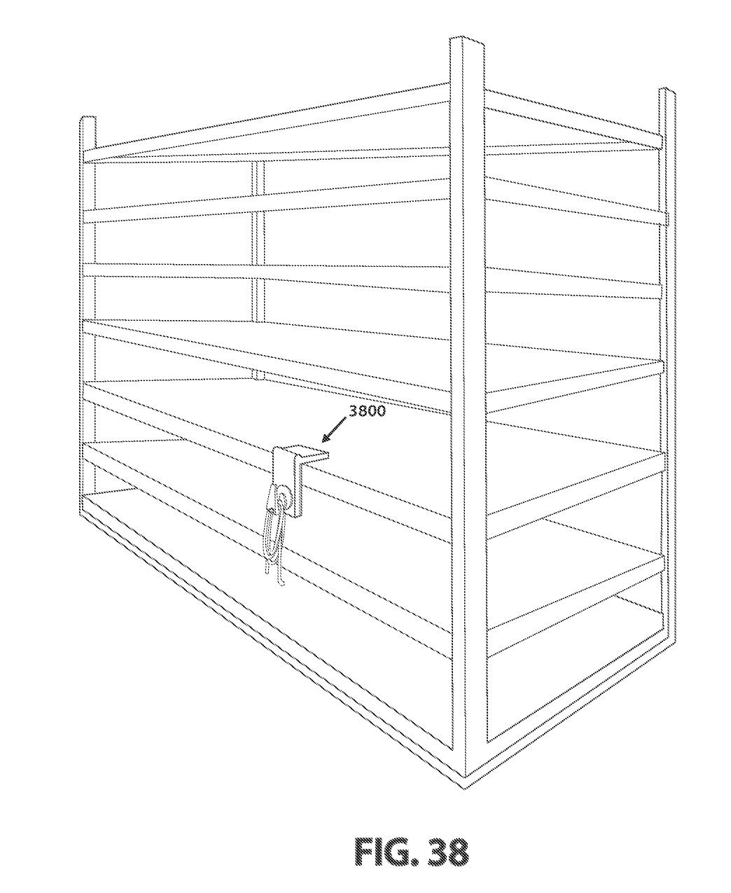

FIG. 38 is an illustration of one embodiment of the accessory mount assembly and shows the accessory mount assembly attached to a storage shelf. Specifically, the accessory mount assembly 3800 may include magnetic fasteners that removeably attach to a metallic surface of the storage shelf. FIG. 38 also shows that the accessory mount assembly 3800 may have a hook as an accessory for holding a piece of wire.

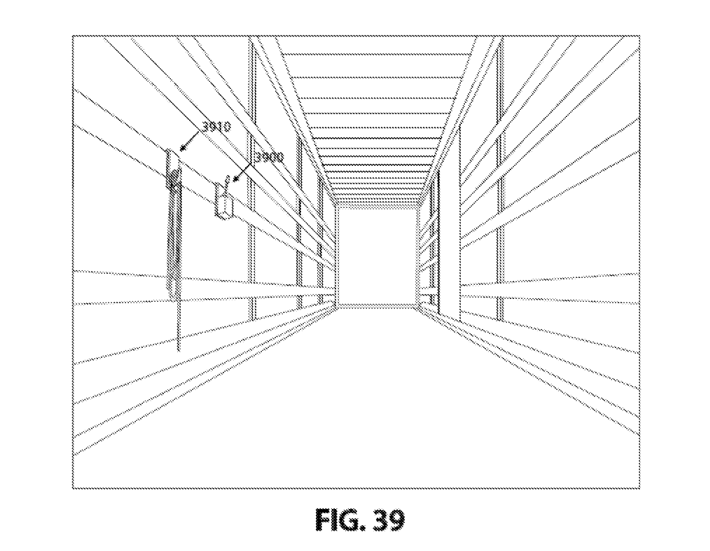

FIG. 39 is an illustration of additional embodiments of the accessory mount assembly and shows the accessory mount assemblies attached to a metal beam and metal frame of a semi-truck. As shown in FIG. 39, the accessory mount assemblies may include: a first accessory mount assembly 3900 and second accessory mount assembly 3910. The first accessory mount assembly 3900 and second accessory mount assembly 3910 may include magnetic fasteners that removeably attach to the metal beam and metal frame of the semi-truck. FIG. 39 also shows that the first accessory mount assembly 3900 may have a container as an accessory for holding a screwdriver and that the second accessory mount assembly 3910 may have a hook as an accessory for holding a piece of rope.

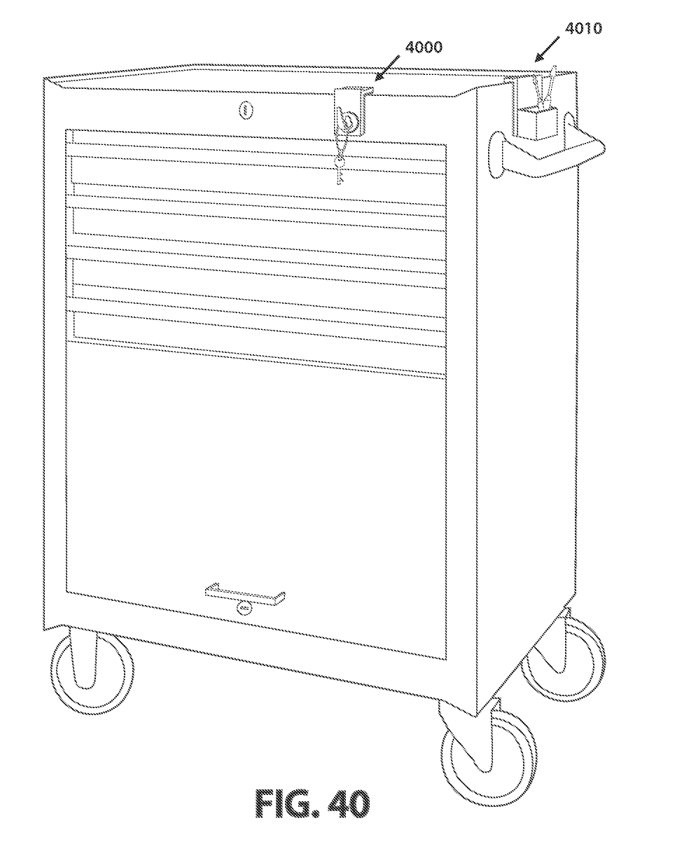

FIG. 40 is an illustration of additional embodiments of the accessory mount assembly and shows the accessory mount assemblies attached to a roller cabinet. As shown in FIG. 40, the accessory mount assemblies may include: a first accessory mount assembly 4000 and second accessory mount assembly 4010. The first accessory mount assembly 4000 and second accessory mount assembly 4010 may include magnetic fasteners that removeably attach to the roller cabinet. FIG. 40 also shows that the first accessory mount assembly 4000 may have a hook as an accessory for holding a key and that the second accessory mount assembly 4010 may have a container as an accessory for holding two screwdrivers.

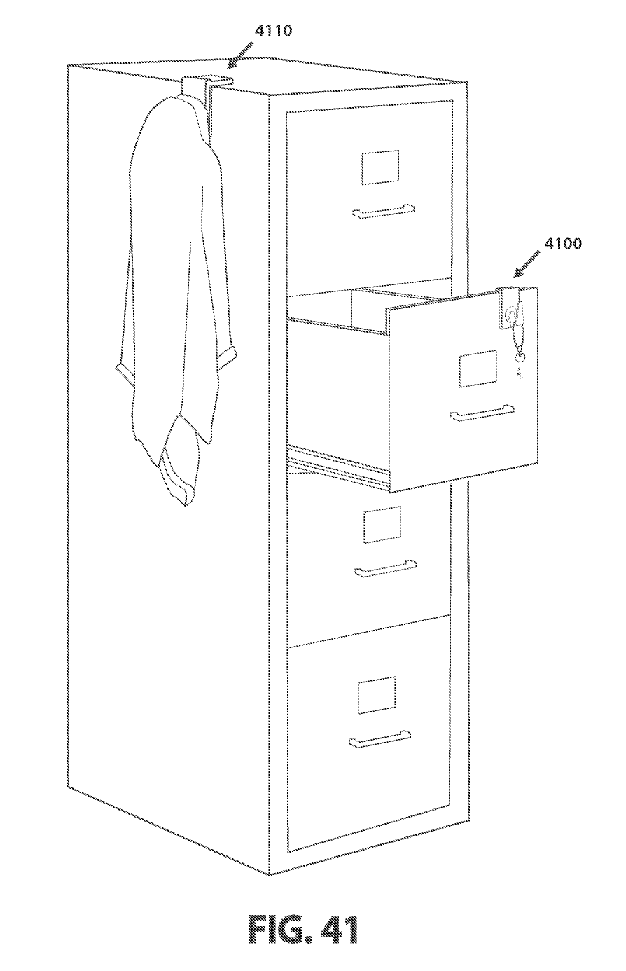

FIG. 41 is an illustration of additional embodiments of the accessory mount assembly and shows the accessory mount assemblies attached to a filing cabinet. As shown in FIG. 41, the accessory mount assemblies may include: a first accessory mount assembly 4100 and second accessory mount assembly 4110. The first accessory mount assembly 4100 and second accessory mount assembly 4110 may include magnetic fasteners that removeably attach to the filing cabinet. FIG. 41 also shows that the first accessory mount assembly 4100 may have a hook as an accessory for holding a key and that the second accessory mount assembly 4110 may have a hook as an accessory for holding a sweater.

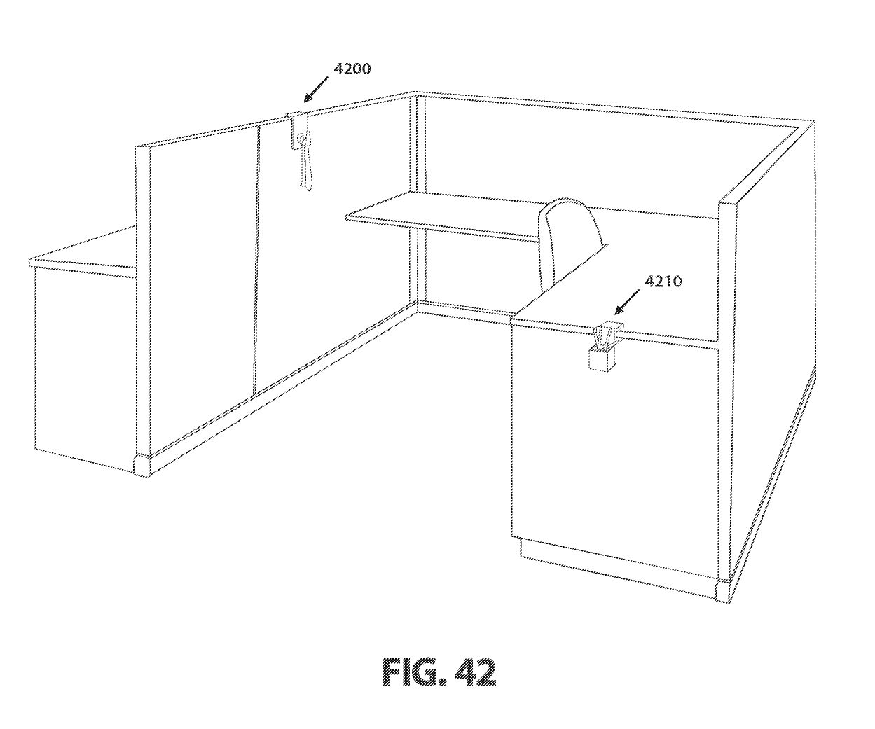

FIG. 42 is an illustration of additional embodiments of the accessory mount assembly and shows the accessory mount assemblies attached to a wall of a cubicle and onto a ledge of a desk. As shown in FIG. 42, the accessory mount assemblies may include: a first accessory mount assembly 4200 and second accessory mount assembly 4210. The first accessory mount assembly 4200 may include an adhesive fastener that removeably attaches to the wall of the cubicle. The second accessory mount assembly 4210 may also include an adhesive fastener that removeably attaches to the ledge of the desk. FIG. 42 also shows that the first accessory mount assembly 4200 may have a hook as an accessory for holding a tie and that the second accessory mount assembly 4210 may have a container as an accessory for holding pencils.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A customizable organizer assembly, comprising:
a fixture assembly; and
one or more accessory mount assemblies;
wherein said fixture assembly comprises of a fixture housing and one or more first fasteners;
wherein said one or more accessory mount assemblies comprise: an accessory mount housing, an accessory, a hood, and one or more second fasteners;
wherein said fixture assembly is configured to attach onto a surface;
wherein said accessory performs at least one organizational function;
wherein said hood is an upper portion of said each of said one or more accessory mount assemblies; and
wherein said one or more first fasteners are configured to matingly engage with said one or more second fasteners to allow said one or more accessory mount assemblies to removeably attach to said fixture assembly.

2. The customizable organizer assembly of claim 1, wherein said fixture assembly further comprises of a faceplate;
wherein said faceplate is attached to said fixture housing;
wherein said faceplate includes at least one of said one or more first fasteners;
wherein said at least one of said one or more first fasteners of said faceplate is configured to contact said one or more second fasteners of said one or more accessory mount assemblies, such that said one or more accessory mount assemblies removeably attach to said fixture assembly.

3. The customizable organizer assembly of claim 1, wherein said fixture housing comprises a hood receiver;
wherein said hood receiver is an upper portion of said fixture assembly; and
wherein said one or more accessory mount assemblies matingly engage with said fixture assembly, such that said one or more first fasteners matingly engage with one or more second fasteners and said hood receiver supports said hood.

4. The customizable organizer assembly of claim 1, wherein said fixture housing comprises of a hood receiver and a base receiver;
wherein said hood receiver is an upper portion of said fixture assembly;
wherein said base receiver is a lower portion of said fixture assembly;
wherein each of said one or more accessory mount assemblies are comprised of a base;
wherein said base is a lower portion of said each of said one or more accessory mount assemblies; and
wherein said one or more accessory mount assemblies removeably engage with said fixture assembly, such that said hood matingly engages with said hood receiver and said base matingly engages with said base receiver, such that said fixture assembly supports said one or more accessory mount assemblies.

5. The customizable organizer assembly of claim 4, wherein said base receiver of said fixture housing is a snug-fit base receiver;
wherein said one or more accessory mount assemblies are one or more snug-fit accessory mount assemblies, such that said base of said one or more accessory mount assemblies is a snug-fit base; and
wherein said one or more snug-fit accessory mount assemblies removeably and matingly engage with said fixture assembly, such that said snug-fit base engages with said snug-fit base receiver.

6. The customizable organizer assembly of claim 3, wherein said hood receiver of said fixture assembly is a trench-hood receiver;
wherein said hood of said one or more accessory mount assemblies is a trench-hood; and
wherein said trench-hood is configured to matingly engage with said trench-hood receiver, such that said fixture assembly substantially secures said one or more accessory mount assemblies.

7. The customizable organizer assembly of claim 3, wherein said hood receiver of said fixture assembly is a curved-hood receiver;
wherein said hood of said one or more accessory mount assemblies is a curved-hood; and
wherein said curved-hood is configured to matingly engage with said curved-hood receiver, such that said fixture assembly supports with reduced slippage said one or more accessory mount assemblies.

8. The customizable organizer assembly of claim 1, further comprising a bin assembly;
wherein said fixture assembly comprises of a bin receiver; and
wherein said bin assembly removeably engages with said bin receiver of said fixture assembly.

9. The customizable organizer assembly of claim 1, further comprising a cover assembly;
wherein said cover assembly comprises of a hood and a base;
wherein said fixture assembly comprises of a cover receiver and base receiver;
wherein said hood of said cover assembly removeably engages with said cover receiver of said fixture assembly; and
wherein said base of said cover assembly removeably engages with said base receiver of said fixture assembly.

10. The customizable organizer assembly of claim 1, further comprising one or more extensions;
wherein a first end of said one or more extensions are attached to said surface; and
wherein a second end of said one or more extensions is attached to said fixture assembly, such that said fixture assembly is secured to and extended from said surface.

11. The customizable organizer assembly of claim 1, further comprising one or more extension mounting brackets and one or more extensions;
wherein said one or more extension mounting brackets are attached to said surface;
wherein a first end of said one or more extensions are attached to said one or more extension mounting brackets; and
wherein a second end of said one or more extensions is attached to said fixture assembly, such that said fixture assembly is secured to and extended from said surface.

12. The customizable organizer assembly of claim 11, wherein said one or more extensions is selected from the group consisting of: a hanger; a bar; and an L-shaped bracket.

13. The customizable organizer assembly of claim 1, wherein said one or more accessory mount assemblies are one or more bracket-shaped accessory mount assemblies.

14. The customizable organizer assembly of claim 1, wherein said one or more accessory mount assemblies are one or more L-shaped accessory mount assemblies.

15. A customizable organizer assembly, comprising:
one or more accessory mount assemblies;
wherein said one or more accessory mount assemblies comprise of:
at least one accessory mount housing;
at least one hood;
one or more second fasteners; and
at least one accessory;
wherein said one or more second fasteners is configured to removeably attach to one or more surfaces, such that said one or more accessory mount assemblies removeably attach to said one or more surfaces;
wherein said at least one hood is configured to contact a second surface, such that said at least one hood supports said one or more accessory mount assemblies; and
wherein said at least one accessory performs at least one organizational function and holds and stores one or more items.

16. The customizable organizer assembly of claim 15, wherein said one or more second fasteners are one or more magnets; and
wherein said one or more surfaces are one or more metal surfaces, such that said one or more accessory mount assemblies removeably attach to said one or more surfaces.

17. The customizable organizer assembly of claim 15, wherein said one or more second fasteners are one or more metals; and
wherein said one or more surfaces include at least one magnet, such that said one or more accessory mount assemblies removeably attach to said one or more surfaces.

18. The customizable organizer assembly of claim 15, wherein said one or more second fasteners are one or more adhesive fasteners; and
wherein said one or more surfaces includes at least one of said one or more adhesive fasteners attached to said one or more surfaces, such that said one or more accessory mount assemblies removeably attach to said one or more surfaces.

19. The customizable organizer assembly of claim 15, wherein said one or more second fasteners is permanently attached to said one accessory mount housing.

20. The customizable organizer assembly of claim 15, wherein said one or more second fasteners is detachable from said one accessory mount housing.

21. The customizable organizer assembly of claim 15, wherein said at least one accessory is permanently attached to said one accessory mount housing.

22. The customizable organizer assembly of claim 15, wherein said at least one accessory is detachable from said one accessory mount housing.

23. The customizable organizer assembly of claim 15, wherein said one or more accessory mount assemblies further comprises of one or more upper finger grips;
wherein said one or more upper finger grips are located at an upper portion of said one or more accessory mount assemblies; and
wherein said one or more upper grips are configured to assist a user to dismount said one or more accessory mount assemblies from said one or more surfaces.

24. The customizable organizer assembly of claim 15, wherein said one or more accessory mount assemblies further comprises of one or more lower finger grips;
wherein said one or more lower finger grips are located at a lower portion of said one or more accessory mount assemblies; and
wherein said one or more lower grips are configured to assist a user to dismount said one or more accessory mount assemblies from said one or more surfaces.

25. The customizable organizer assembly of claim 15, wherein said one or more surfaces are edges of one or more utility carts, such that said one or more accessory mount assemblies removeably attach to said one or more utility carts; and
wherein said organizational function is to hold and store one or more items.

26. The customizable organizer assembly of claim 15, wherein said one or more surfaces are one or more magnetic knife holders and one or more magnetic tool holders, such that said one or more accessory mount assemblies removeably attach to said one or more magnetic knife holders and one or more magnetic tool holders.

27. The customizable organizer assembly of claim 15, wherein said one or more surfaces are edges of one or more retail display equipment of a store such that said one or more accessory mount assemblies removeably attach to said one or more retail display equipment of said store;
wherein said one or more retail display equipment is selected from the group consisting of: a shelf; a refrigerator; a standing sign; and a store rack;
wherein said at least one accessory is selected from the group consisting of: a hook; a hanger; a rack; a display; a sign holder; a sign; a tray; a shelf; and
wherein said organizational function of said one or more accessory mount assemblies is selected from the group consisting of: organizing one or more items; displaying one or more prices; displaying one or more advertisements; displaying one or more promotions; and displaying one or more products.

28. The customizable organizer assembly of claim 15, wherein said one or more surfaces are edges of one or more storage shelves, such that said one or more accessory mount assemblies removeably attach to said one or more storage shelves; and
wherein said one or more storage shelves in combination with said one or more accessory mount assemblies become said customizable organizer assembly to hold and store one or more items and to organize said one or more items.

29. The customizable organizer assembly of claim 15, wherein said one or more surfaces are edges of one or more metal beams and one or more metal frames of a semi-truck, such that said one or more accessory mount assemblies removeably attach to said one or more metal beams and one or more metal frames of a semi-truck; and
wherein said organizational function is to hold and store one or more items hang one or more items.

30. The customizable organizer assembly of claim 15, wherein said one or more surfaces are one or more edges of an assembly line workspace in a factory, such that said one or more accessory mount assemblies removeably attach to said one or more edges of said assembly line workspace in said factory; and
wherein said organizational function is to hold and store one or more items.

31. The customizable organizer assembly of claim 15, wherein said one or more surfaces are one or more walls of a cubicle of an office building, such that said one or more accessory mount assemblies removeably attach to said one or more walls of said cubicle of said office building; and
wherein said organizational function is to hold and store one or more items.

32. The customizable organizer assembly of claim 15, wherein said one or more surfaces are one or more filing cabinets, such that said one or more accessory mount assemblies removeably attach to said one or more filing cabinets; and
wherein said organizational function is to hold and store one or more items.

33. The customizable organizer assembly of claim 15, wherein said one or more surfaces are one or more workspaces of a tooling shop, such that said one or more accessory mount assemblies removeably attach to said one or more workspaces of said tooling shop using said one or more second fasteners; and
wherein said organizational function is to hold and store one or more items.
